(19) United States
(12) Patent Application Publication
(10) Pub. No.: US 2010/0023355 A1
(43) Pub. Date: Jan. 28, 2010

(54) Method and System of Developing a Product

(75) Inventors: Ty R. Sagalow, Syosset, NY (US); Charles P. Orlowicz, Rutherford, NJ (US); Susan E. Burell, Land O'Lakes, FL (US); Phyllis Ann Mooney, Red Bank, NJ (US); Robert E. Johnson, Middletown, NJ (US); Akiko Shimomura, New York, NY (US); Michael Feighan, Philadelphia, PA (US); Leah C. Pedersen, New York, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Americal International Group, Inc., New York, NY (US)

(21) Appl. No.: 12/390,895

(22) Filed: Feb. 23, 2009

Related U.S. Application Data
(63) Continuation of application No. PCT/US09/32734, filed on Jan. 30, 2009.
(60) Provisional application No. 61/025,207, filed on Jan. 31, 2008.

(51) Int. Cl. G06Q 40/00; G06Q 10/00

(52) U.S. Cl. 705/4

(57) ABSTRACT

Aspects of the invention include a method and system to develop a product within a corporate environment comprising diverse business units that are located in geographically dispersed locations. In addition, aspects of the invention provide for a streamlined product development process such that a company can efficiently launch products to market from an idea generation stage. Further aspects of the invention include systems and methods that coordinate product development activities within and between different business units within a company. Additional aspects of the invention provide for systems and methods that improve efficiency, reduce redundancy and provide synergy of expertise between different business units to develop a product.

### CROSS-REFERENCE TO RELATED APPLICATIONS

This patent application is a continuation of PCT/US09/32734, filed Jan. 30, 2009, which claims the benefit of U.S. Provisional Patent Application No. 61/025,207, filed Jan. 31, 2008, which are both incorporated herein by reference in their entirety including all drawing sheets and all description and discussion.

### FIELD OF THE INVENTION

The invention generally relates to a computer-implemented system and method for developing products, and particularly relates to a computer-implemented system and method for documenting, approving, tracking, and managing product development.

### BACKGROUND OF THE INVENTION

In order to compete in the global marketplace, a company typically needs to develop innovative products. However, companies that are organized into different business units located in geographically dispersed offices have many additional challenges in developing new products. It is especially challenging in this context to maintain efficiency and reduce duplicative effort. These challenges in turn may further include gathering creative and diverse product ideas from company employees and coordinating product development activities between its different business units, to improve efficiency, reduce duplicative effort, and provide a full featured, robust product to market.

A company may prefer to coordinate and manage different business units that work on similar product ideas to improve efficiency and minimize duplicate work. Often a large company cannot coordinate the activities of different groups of employees to foster the development of an innovative product to the global marketplace. Instead, many times the different business units each develop their own product based on the same idea, but may each lack features, or include redundant features, relative to one another. In addition, a company that does not coordinate product development between its business units may fail to generate any ideas worthy of product development. Instead, the company may foster a dull work environment void of creativity. Further, a company may not harvest product ideas from all its resources within its different business units because it does not have sufficient processes and computer systems to gather such product ideas. Coordination and management of product development between different units also allows a company to create synergy between business units, e.g., applying expertise from one business unit to product development in another business unit.

### BRIEF SUMMARY OF THE INVENTION

Aspects of the invention include a method and system to develop a product within a corporate environment comprising diverse business units that are located in geographically dispersed locations. In addition, aspects of the invention provide for a streamlined product development process such that a company can efficiently launch products to market from an idea generation stage. Further aspects of the invention include systems and methods that coordinate product development activities within and between different business units within a company. Additional aspects of the invention provide for systems and methods that improve efficiency, reduce redundancy and provide synergy of expertise between different business units to develop a product.

Exemplary stages of a product development process may include Trend Identification, Preliminary Analysis, Scope and Definition, Product Design, Implementation and Product Performance Review. In a Trend Identification stage, a company may foster early awareness of societal changes, demographic shifts, or legislation modifications creating new market opportunities so that the company can gather new product ideas to meet new market opportunities. A new product idea may be reviewed to determine viability through an analysis of product demand, operations, and distribution during a Preliminary Analysis stage. In a Scope and Definition stage, a product idea may be further researched to determine its financial profitability to the company. Further, a product is designed for the market based on the product idea during a Product Design stage. Sales training and other preparations for product launch are conducted during an Implementation stage. During the Product Performance stage, the financial performance of the product is reviewed after the product is launched in the marketplace to determine whether any adjustments need to be made to increase its financial viability.

Exemplary components of a system for product development may include a central repository or database for product ideas, a Product Development (PD) team, and a New Product Council to coordinate product development activities between and within business units, one or more computer servers executing software applications that assist PD team and New Product Council members in managing the product development process, one or more electronic databases that store the different work product generated during a product development process, business unit personnel that work with a PD team to develop an idea into a product and launch into the marketplace, and training software applications that may be in the form of webcasts or other media, to assist in training sales personnel on the different facets of the new product.

Business units of a company may need to foster a culture of creativity, according to aspects of the invention. It may be the responsibility of the leadership of each business unit to ingrain a culture of creativity into every aspect of a business and employee's daily routine. This creative environment begins with the support of senior executives within each business unit who recognize the importance of new products and communicate its importance to their staff.

### BRIEF DESCRIPTION OF THE SEVERAL VIEWS OF THE DRAWINGS

FIG. 1 shows an exemplary computer network environment that is used in a system or method for developing a product, according to an aspect of the invention;

FIG. 2 shows exemplary computer systems that are involved in a product development method, according to an aspect of the invention;

FIGS. 3-4 are flow diagrams of exemplary steps for a method to develop a new product, according to aspects of the invention;

FIG. 5A shows a New Product Council that is part of a system for developing a product, according to an aspect of the invention;

FIGS. 5B-5G are exemplary user interfaces of a computer system that provide one or more databases and software applications to assist a company in a product development process, according to an aspect of the invention.

FIG. 6 shows a New Product Incentive Program that is part of a system for developing a product, according to an aspect of the invention;

FIGS. 7-10A illustrate exemplary steps of an idea generation stage within a product development process, according to an aspect of the invention;

FIGS. 10B-10E are exemplary user interfaces that allow company personnel to submit a product idea into a computer system, according to an aspect of the invention.

FIG. 11 is a flow diagram that shows exemplary steps in an Evaluation Idea within a product development process, according to an aspect of the invention;

FIG. 12A shows exemplary sections of a Preliminary Analysis memorandum that is an exemplary component of a product development system, according to an aspect of the invention;

FIG. 12B is an exemplary user interface that shows a list of product ideas in the Pre-Development stage;

FIG. 12C is an exemplary user interface that lists submitted ideas that have been rejected;

FIG. 13A is a flow diagram that shows exemplary steps in developing a product idea as stage of a Product Idea Development stage of a product development process, according to an aspect of the invention;

FIG. 13B is an exemplary user interface that shows a list of product ideas in the In-Development stage of a product development process, according to an aspect of the invention;

FIG. 14 is a flow diagram that shows the exemplary steps in a Designing Product as a stage of a product development process, according to an aspect of the invention;

FIG. 15 is a flow diagram that shows the exemplary steps in a Marketing Product as a stage of a product development process, according to an aspect of the invention;

FIG. 16 is a flow diagram that shows the exemplary steps in a Validating Product as a stage of a product development process, according to an aspect of the invention;

FIG. 17 is a flow diagram that shows the exemplary steps in an Approval obtaining from various company personnel as a stage of a product development process, according to an aspect of the invention;

FIG. 18 is a flow diagram that shows the exemplary steps in a Launching Product as a stage of a product development process, according to an aspect of the invention;

FIG. 19A is a flow diagram that shows the exemplary steps in a Monitoring Product as a stage of a product development process, according to an aspect of the invention;

FIG. 19B is an exemplary user interface that shows a list of product ideas in the In-Development stage;

FIG. 19C is a user interface that allows a user to review the tasks for each product idea in a stage of the product development process;

FIG. 19D is an exemplary user interface that lists the tasks of product ideas in a Preliminary Analysis stage;

FIG. 19E is an exemplary user interface that lists the tasks of product ideas in a Product Design stage;

FIGS. 20A-20C are exemplary user interfaces that list the documents or other work product that are listed for each product idea during a stage of the product development process;

FIG. 21A is an exemplary user interface that allows a user to search the ITAM computer system for one or more product ideas based on search criteria entered by the user into data fields or selected from drop down menus; and

FIG. 21B is a list of search results displayed on an exemplary user interface based on search criteria.

### DETAILED DESCRIPTION OF THE INVENTION

Aspects of the invention provide for a method and system for developing a product that include, but is not limited to, a company comprised of several diverse business units located in geographically dispersed offices. Further aspects of the invention provide for a streamlined product development process such that a company can efficiently launch products to market from an idea generation stage. Additional aspects of the invention provide for systems and methods coordinate product development within and between different business units within a company that includes improving efficiency, reducing redundancy and providing synergy between the different business units in developing a product.

Exemplary stages or steps of a product development process may include Trend Identification, Preliminary Analysis, Scope and Definition, Product Design, Implementation and Product Performance Review. Further exemplary stages or steps in a method for product development may include Idea Generation, Idea Evaluation, Product Development, Product Design, Product Launch, and Product Monitoring. The exemplary stages, steps, and sub-steps may overlap. The disclosure describes the different stages in more detail below with reference to the figures. Exemplary sub-steps are also shown for each stage or step. A person of ordinary skill in the art understands that each stage, step or sub-step is exemplary and does not limit any aspect of the invention. Further, a person of ordinary skill in the art would understand that the stages, steps, or sub-steps may be performed in any order. The order of stages, steps, and sub-steps shown in the accompanying figures and associated description are exemplary.

Exemplary components of a system for product development may include a central repository for product ideas, a Product Development (PD) team and New Product Council to coordinate product development activities within and between different business units, one or more computer servers executing software applications that assist PD team New Product Council members in managing the product development process, one or more electronic databases that store the different work product generated during a product development process, business unit personnel that work with a PD team to develop an idea into a product and launch into the marketplace, and training software application that may be in the form of webcasts or other media to assist in training sales personnel on the different features of the new product. Implementing the aforementioned aspects of the invention in a system and method allows a company to efficiently develop innovative products for the global consumer to increase company profits.

The disclosure describes embodiments of the invention that include systems and methods for developing insurance products in an insurance corporate environment. A person of ordinary skill in the art would understand that the principles described in the disclosure may be extended to any corporate environment that develops any type of product and are not limited to an insurance company developing insurance products.

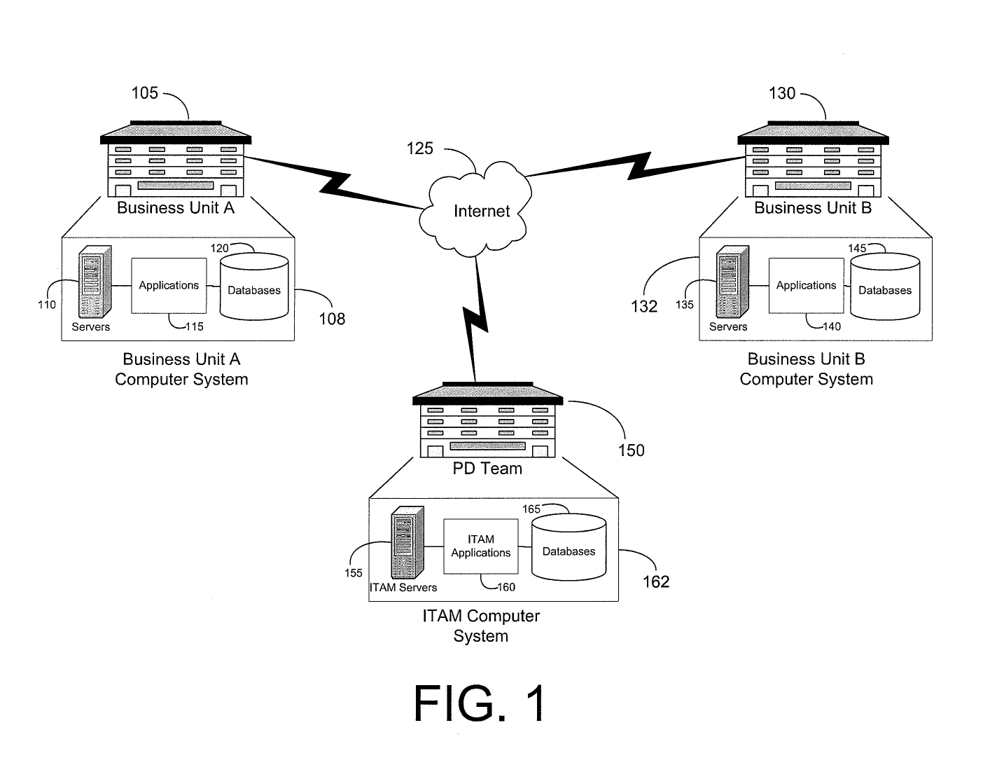

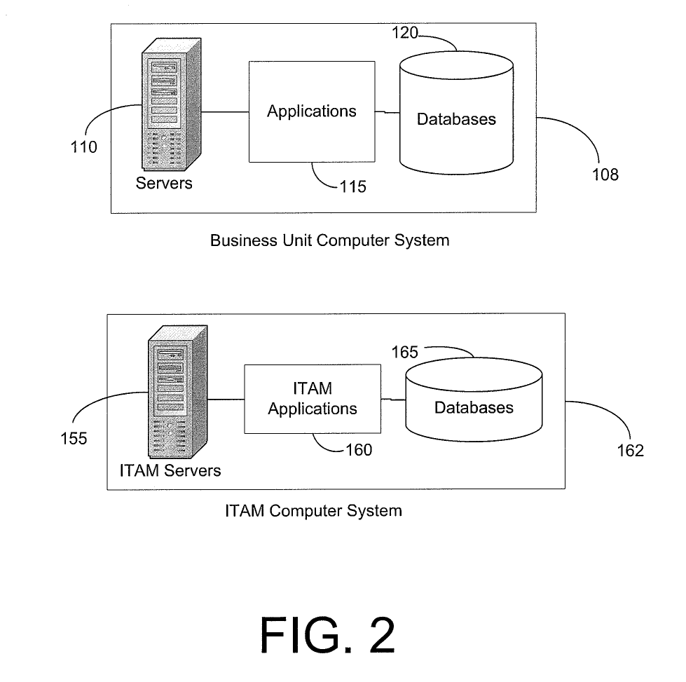

FIG. 1 shows an exemplary computer network environment that is used in a system or method for developing a product, according to an aspect of the invention. FIG. 1 shows business units of the company (105, 130) comprised of local computer systems (108, 132) that are connected to each other via the Internet 125. Each local computer system (108, 132) for a business unit may comprise one or more computer servers (110, 135), computer software applications (115, 140), and databases (120, 145) as shown in FIG. 2. Each local computer system can access, transfer, or store data to another business unit computer system or to the Innovative Tracking and Management (ITAM) computer system 162. A product development (PD) team of the company may contain the ITAM computer system that comprises one or more ITAM servers 155, computer software applications 160, and databases 165 (see FIG. 2).

A company may create a PD team 150 that is used across the company by different business units (105, 130). The PD team offers a wide range of services to the company business units because of its interaction in developing the diverse nature of products offered by the different business units. Further, the PD team can coordinate the product development activities so that it can improve efficiency, reduce redundancy and provide synergy between the different business units in developing a product within the company. An exemplary list of services offered by a PD team for a financial/insurance company may include those listed in Table 1. Each business unit may use as many of the services for developing a new product as desired. This may include total end-to-end project management of the new product development or subset of the PD team's services. The diverse experience and expertise of the PD team also provides this unique benefit to business units that want to undertake a comprehensive product initiative that is complex and may require a lot of coordination among business units.

TABLE 1
PD Team Services

| | |
|---|---|
| Total Project Management | Reinsurance Placement |
| Comprehensive Research | Financial Analysis and Pro-Forma |
| | P&L Creation |
| Product Demand Analysis | Marketing Strategies and |
| | Communications Implementation |
| Underwriting Assessment Analysis | Claims Expertise |
| Distribution Assessment Analysis | Sales and Business Development |
| Legal Drafting | Technology and Operations |
| Actuarial and Rating Plan Creation | |

Another aspect of the invention shown in FIG. 1 is an ITAM computer system. ITAM comprises an innovative product development database and project management software tools. In addition, ITAM may act as a central repository for new product ideas. The database feature and project management software tools allow a member of a PD team or New Product Council to track and generate reports on new product idea submissions. ITAM also provides a PD team with desktop dashboard management tools that are updated periodically.

The project management features of ITAM are specifically designed to meet the unique needs of a product development process. ITAM allows users to follow the PD team's end-to-end product development management. Each new product idea is assigned its own electronic folder that can hold all of the electronic documents and notes generated by the product development team. The first tab of each product idea electronic folder provides an executive summary of the idea which can be searched for easy reporting. Each development stage within ITAM provides the user with a checklist of best practice tasks. ITAM also allows users to customize the folders for any unique developmental needs a product may have. ITAM also provides for participants in a product development process to store and manage documents and other work product (e.g., spreadsheets, images, audio, video, etc.) that is generated during the various stages of the product development process. Access to ITAM is available to all business units and ongoing training on its use is provided by a PD team. All of the facts of the product development process may be optimized by the utilization of ITAM.

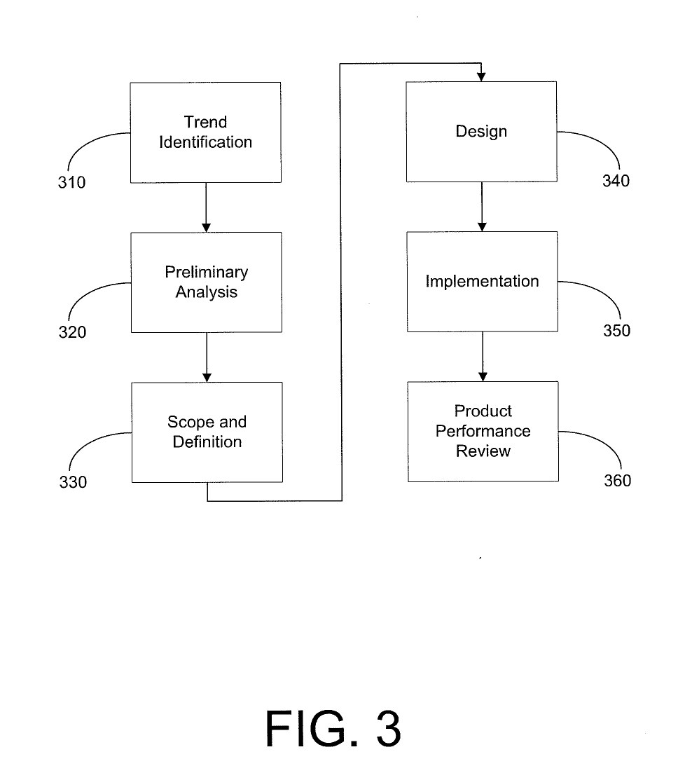

FIG. 3 shows exemplary steps for a method to develop a product, according to an aspect of the invention. Exemplary steps of the method may include Trend Identification 310, Preliminary Analysis 320, Scope and Definition 330, Design 340, Implementation 350, and Product Performance Review 360. A Trend Identification stage 310 may include early awareness of societal changes creating new or increased risk that could be the subject of an insurance product. A Preliminary Analysis stage 320 may involve reviewing the new product idea to determine if sufficient information can be gathered about the risk to perform an early assessment of Demand, Underwriting and Distribution. A Scope and Definition stage 330 may include partnering with a business unit such that the new product idea is further assessed to determine if it can be profitably underwritten. A Product Design stage 340 may involve partnering with a business unit so that different components of an insurance policy are created, including a policy form, rater, application, marketing plan, etc. An Implementation stage 350 may include underwriting and broker training sessions are completed and a launch event for the product is held. A Product Performance Review stage 360 may include three, six and twelve month reviews of the product's performance are done with the business unit to determine if the product needs to be adjusted.

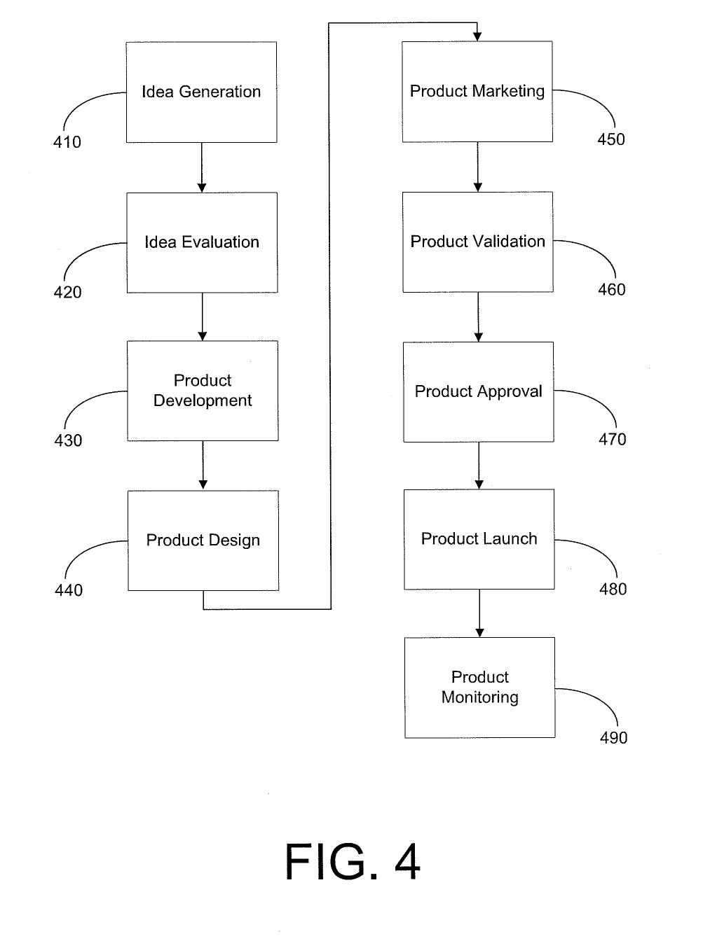

FIG. 4 is a flow diagram of further exemplary steps in a method to develop a new product according to an aspect of the invention. The steps of the exemplary method shown in FIG. 4 may overlap with the exemplary steps shown in FIG. 3. At a step 410, a company generates new product ideas such that company personnel submit and/or the company receives electronically new product ideas and may store them in an ITAM computer system. This step may include defining and classifying new product ideas as well as identifying the areas of change from which most new product ideas emerge. This step may also identify the internal and external resources from which new product ideas may be fathered. New product ideas may be submitted by personnel, or gathered by the company, electronically using ITAM idea submission software tools and stored in ITAM electronic databases. At a step 420, company personnel evaluate the generated ideas. Idea evaluation for an insurance product idea includes assessing demand, underwriting and distribution. Evaluation of product ideas in other industries may include assessing supply, manufacturing, and operations for the product idea. The company may also develop a new product idea at a step 430. Development of an insurance product includes forming a development team, formulating a project plan, drafting a policy form, planning operations and systems, determining regulatory filings, and planning any third party involvement. At a step 440, a company may design the new product. Product design for an insurance product includes designing a policy form template, a software rating tool, insurance application, underwriting guidelines, quote and bind letters, and planning for marketing, training operations, and systems. A company may also market a new product at a step 450. Product marketing includes product branding, protecting the intellectual property within the product, formulating a marketing campaign, and training sales personnel and distributors. At a step 460, a company may validate a new product. Production validation includes conducting surveys, focus groups and one-on-one interviews with target clients and distributors to evaluate whether the product fulfills customer needs. At a step 470, a company may execute an approval process. Product approval includes ensuring compliance with any government regulations as well as receiving approval from department managers and business unit executives. Product Launch may be another step 480 that includes marketing the product, training sales personnel and distributors, and conducting a launch event. At a step 490, a company monitors the product after launch. Product monitoring includes tracking revenue and financial performance of the product after launch as well as documenting any operation issues in delivering the product to customers.

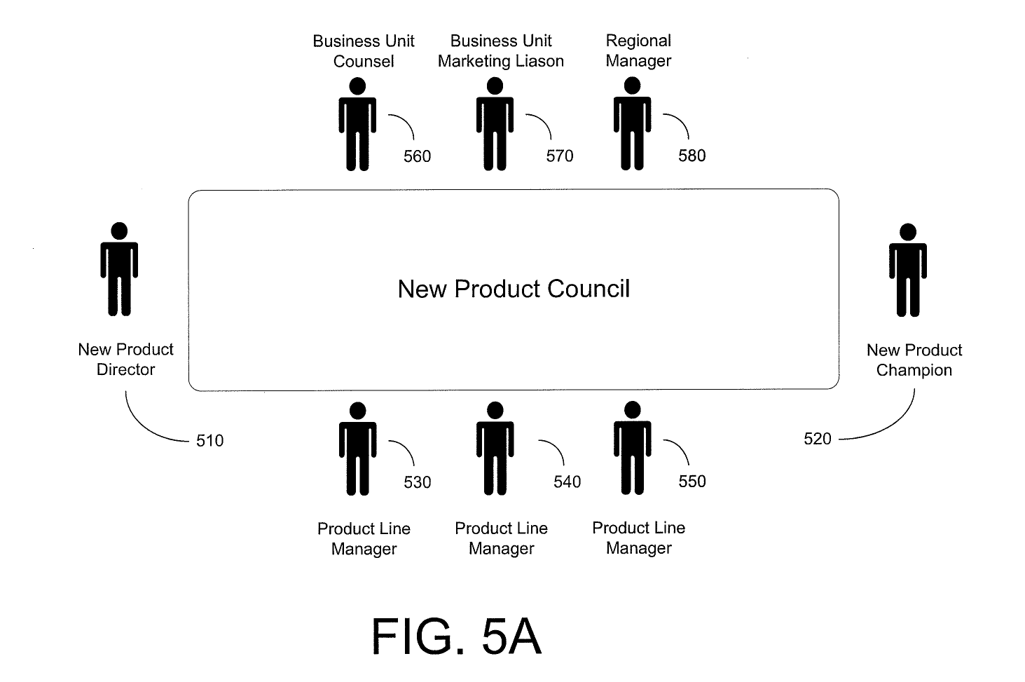

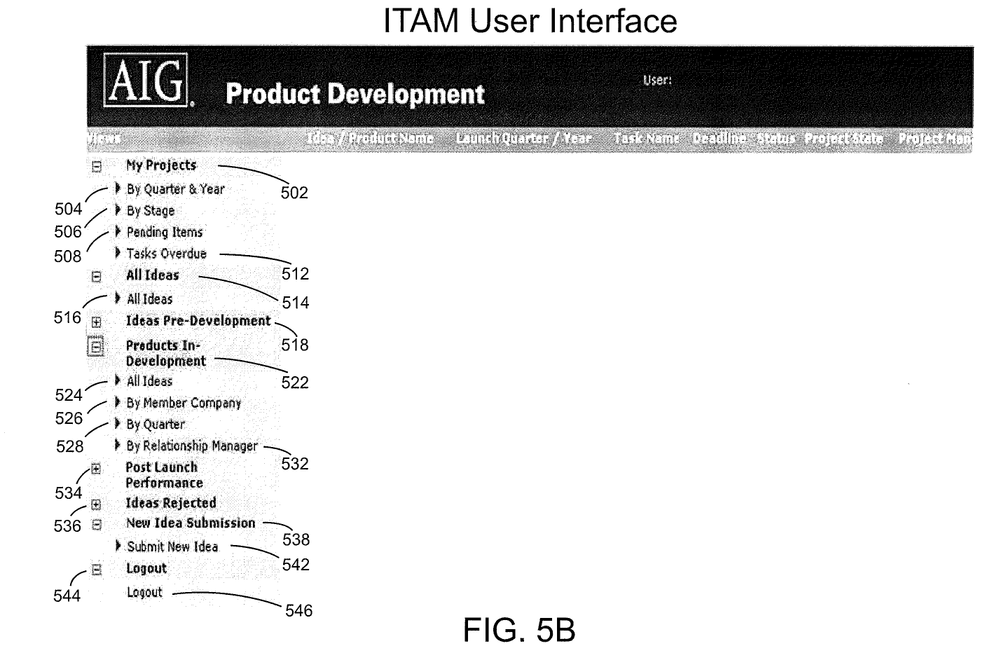

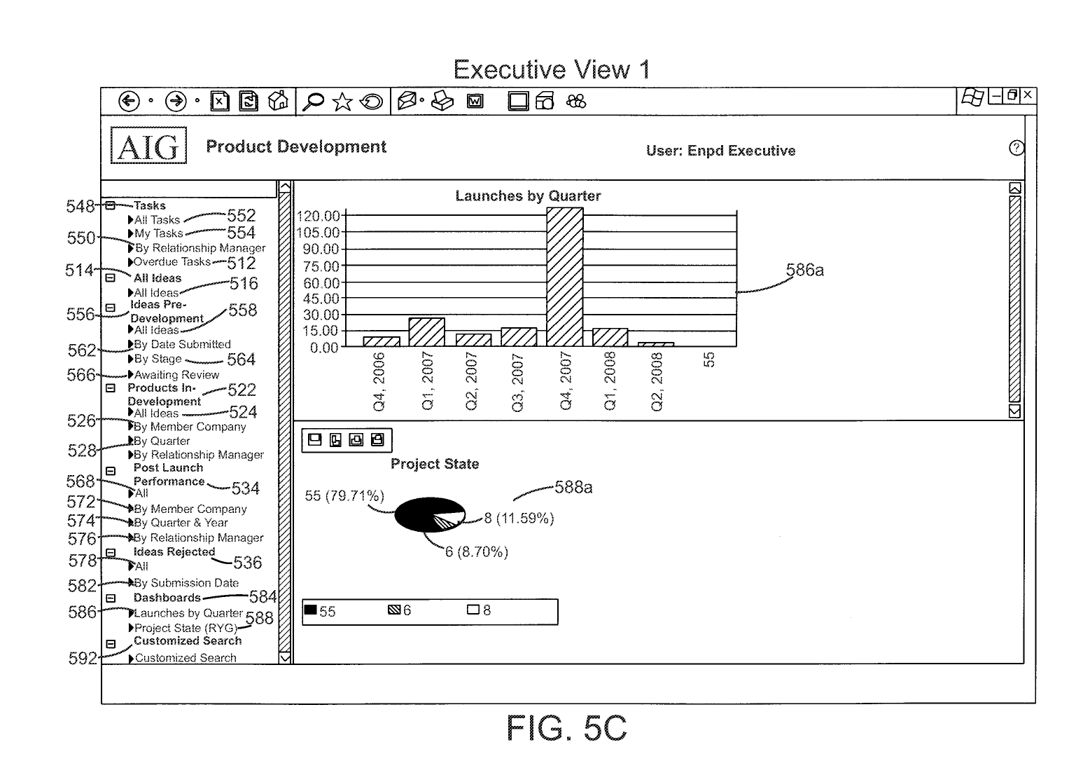

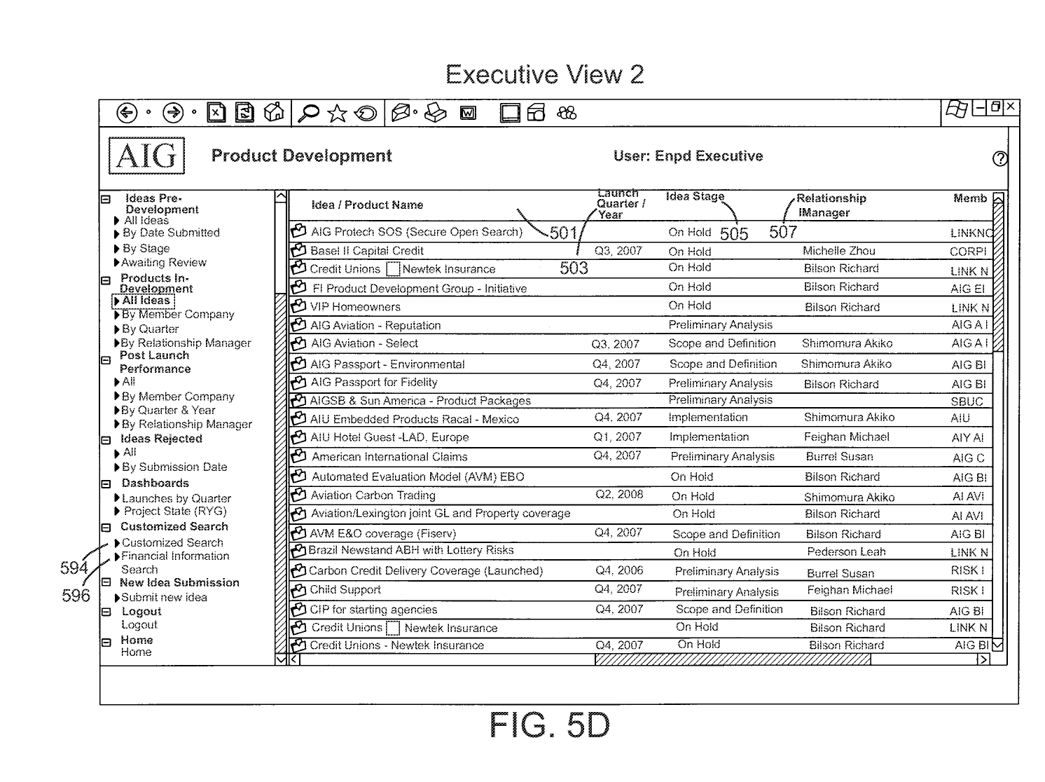

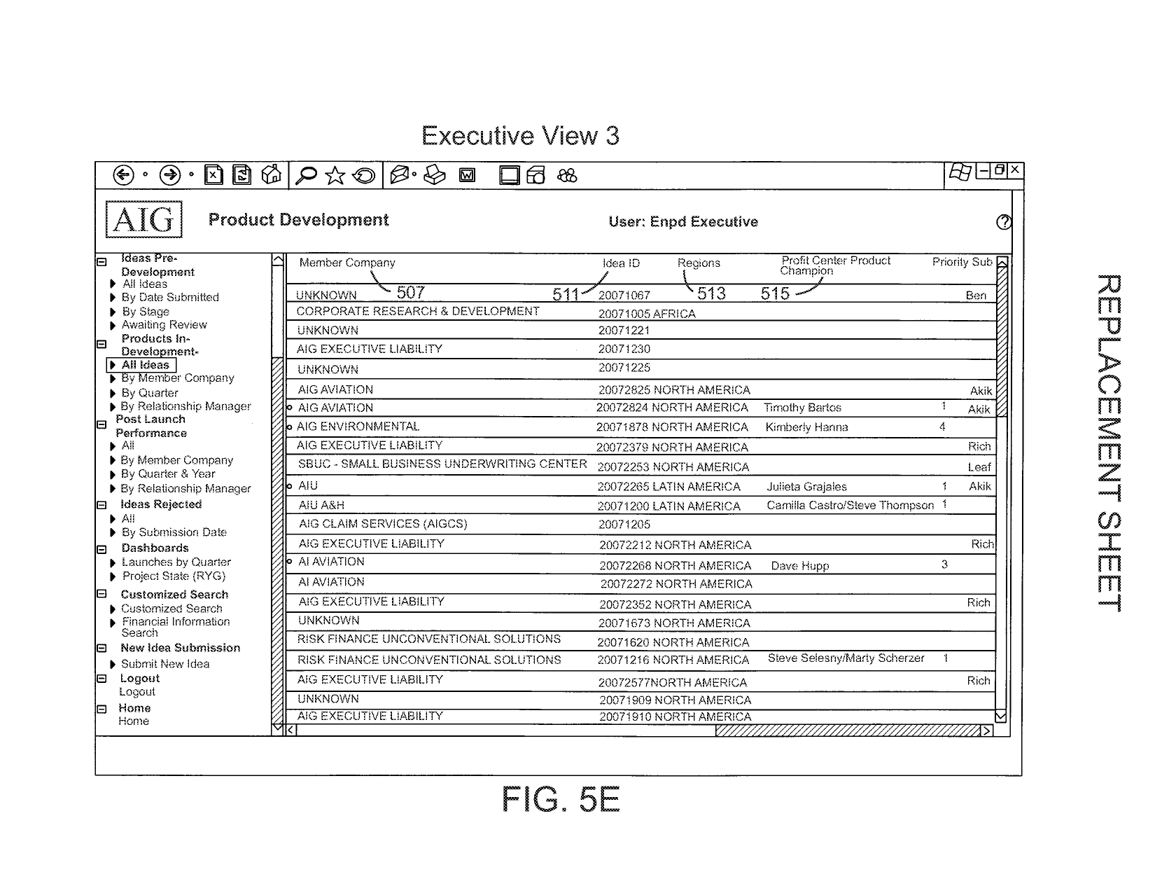

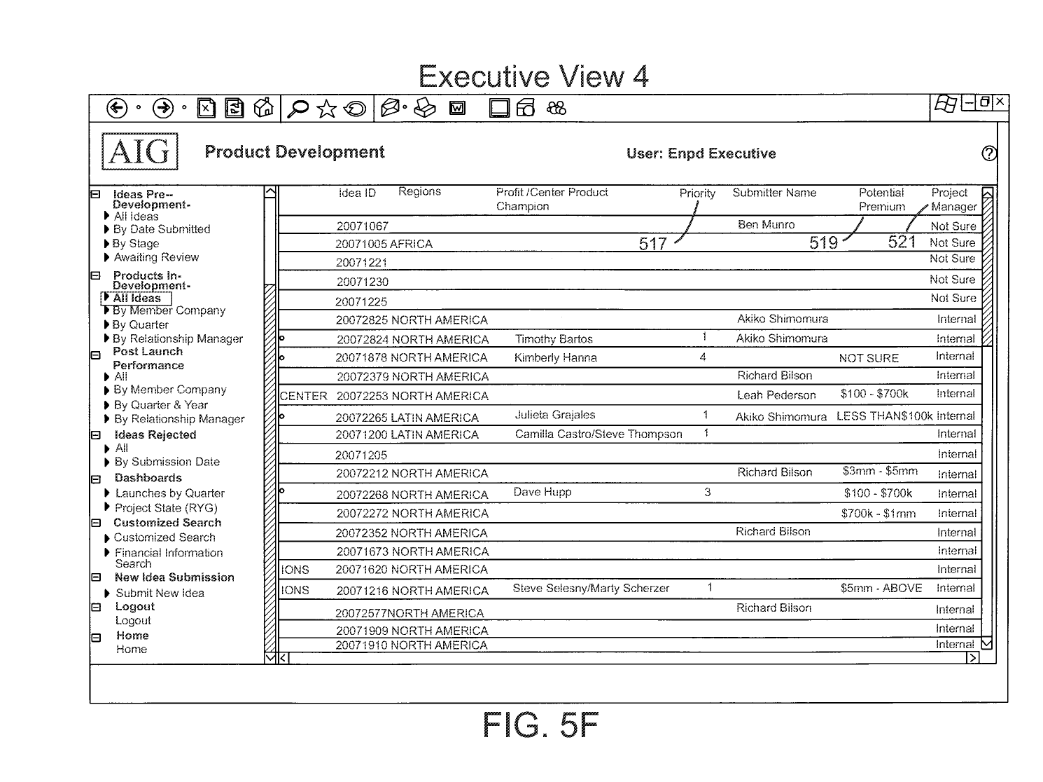

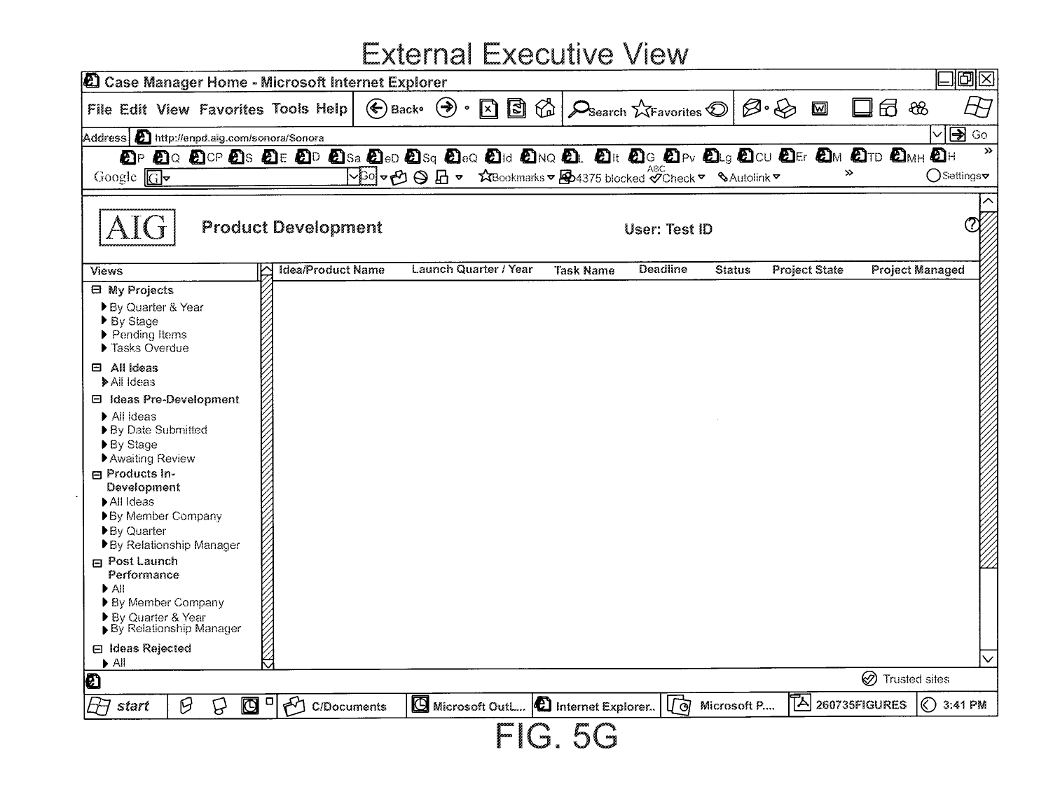

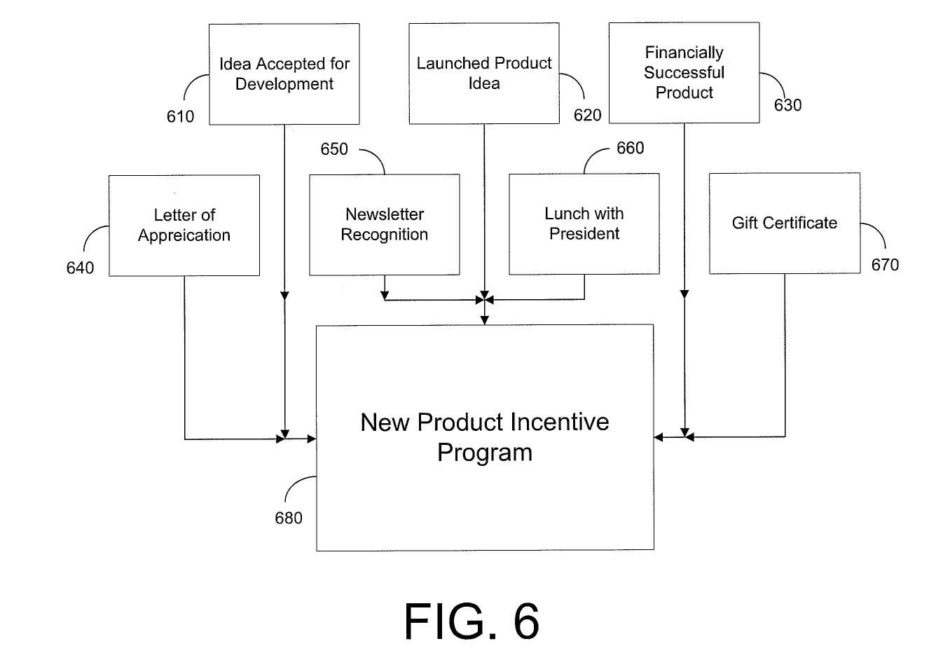

FIG. 5A and FIG. 6 show exemplary components of a system for developing a product according to an aspect of the invention. These include a New Product Council 590, and a New Product Incentive Program 680. The formation of a Product Innovation Council in each business unit provides that the company and its New Product Director 510 conduct an organized approach to generating and evaluating new ideas. The New Product Director 510 leads and organizes a Product Innovation Council 590 which may consist of managers from each of the business unit's major product lines (530-550). Personnel from regional 580, legal 560, and marketing 570 should also be included in the Product Innovation Council 590. The purpose of the Product Innovation Council 590 is to gather new product ideas, review submitted ideas, and recommend ideas that have been evaluated to senior management for development.

The company PD team may train each member of the Product Innovation Council and assist with communications to a business unit's different regions. For example, the PD Team can work with a New Product Director to create webcasts that present the Product Innovation Council 590 to the business unit personnel and initiate new incentive programs.

Each New Product Director 510 is a dedicated resource within their business unit charged with overseeing new product idea generation and development. Their responsibilities cover a wide range of activities including idea generation, idea validation, project oversight, and product post-launch performance review. Fostering idea generation within a business unit includes fostering interaction with staff, brokers and clients to discuss product needs. Idea validation involves reviewing ideas with the Product Innovation Council and PD team. Project oversight includes assigning a Product Champion to each new idea. Product post-launch performance review includes tracking new product sales.

A New Product Director 510 is responsible for product development and is a key factor to a business unit's success. Experience has shown that it is most effective if the New Product Director 510 is a senior level executive, with sufficient experience to command respect and attention of his staff and work force. The PD team may partner with each New Product Director 510 and assign a PD staff member to the New Product Director 510 that provides support and assistance with all their new product activities. The PD team also facilitates regular meetings for all New Product Directors 510 where they can interact with one another and exchange best practices and ideas.

A New Product Champion 520 is a product line employee who steers a particular product through the development process. The New Product Champion 520 is a key member of the product development team for the particular product. Usually the New Product Champion 520 is a manager or underwriter who has the ultimate responsibility for the product once it is launched.

Another person that may interact with the New Product Council from the PD team is the Relationship Manager (RM). The Relationship Manager is responsible for, inter alia, updating the status of the product ideas that are under development, consolidating product idea recommendations from internal and external sources, and entering product development data into the ITAM system. The RM further serves as a primary product manager for specific product ideas and as a liaison to appropriate stakeholders (department managers, legal, R&D, marketing, etc.) to solicit their expertise. ITAM user interfaces provide a RM with the capability of readily accessing up-to-date information pertaining to all submitted ideas stored with the ITAM system and are developed into products. Different software tools of the ITAM system also allow a relationship manager to efficiently review and assess new ideas to expedite decisions to further develop the idea into a product or reject the idea.

FIGS. 5B-5G are exemplary user interfaces of the ITAM computer system that provide one or more databases and software applications to assist company personnel with the product development process. A user may utilize the software applications accessible from these user interfaces to review and manage the product ideas under development to improve the efficiency of the product development as a whole, or manage the development of a certain product idea in particular. FIG. 5B is an exemplary user interface that allows a member of a New Product Council (e.g., New Product Director, New Product Champion, RM, or any other executive) or PD team to review the status of different product ideas under development. A user may click on a “My Projects” icon 502 and review the number of ideas being developed in a given quarter and year by clicking a link 504. Further, a user may review the different product ideas under development by development stage by clicking another link 506. In addition, a user may review pending items in a product development process or tasks that are overdue in the product development process by clicking the appropriate links (508, 512). Pending items may be tasks that are not yet due, while overdue items may be uncompleted tasks that are past their deadline.

The user interface also allows a user to review products that are in the Pre-development, In-development and Post Launch stages of product development by clicking on the appropriate links (518, 522, and 534). The Pre-Development stage of a product development process may overlap with the Idea Generation and Idea Evaluation steps shown in FIG. 4. Further, the In-development stage may overlap with the Product Development, Product Design, Product Marketing, Product Validation, Product Approval, and Product Launch steps as shown in FIG. 4. In addition, the Post Launch Performance stage may overlap with the Product Monitoring step shown in FIG. 4. A user may review the status of all ideas in the In-Development Stage by clicking a link 524 as well as by ideas assigned to a particular business unit, by ideas submitted in a quarter, and by ideas assigned to a particular RM by clicking the appropriate links (526, 528, and 532). A user may also review all submitted ideas by clicking the appropriate links (514 and 516) as well as reviewing all rejected ideas 536. A user may submit a new idea by clicking the appropriate links (538 and 542) as well as logout of the ITAM computer system (544 and 546).

FIG. 5C is an exemplary user interface that shows the status of product ideas in different stages of development using software dashboard applications. A bar graph in the middle of the user interface 586a shows the number of products launched per quarter by the company. The pie chart 588a shows the various states of different product ideas in development. The pie chart shows fifty-five products launched during the current quarter, eight product ideas in development, and six ideas that are not yet in development (e.g., Rejected or in a Pre-development stage). The left side of the user interface shown in FIG. 5C has some of the same functionality shown in the user interface pictured in FIG. 5B. Further functionality provided in the user interface may include providing for a user to review all tasks, the user's individual tasks, tasks assigned to a particular RM, and overdue tasks in developing certain product ideas by clicking the appropriate links (548, 552, 554, 556, 512). Further, the user may review all ideas in the Pre-development stage, or review them by submission date, by stage or by those awaiting review by clicking the appropriate links (556, 558, 562, 564, and 566). In addition, the user can review all ideas in a Post Launch Performance stage by business unit, by quarter, or by RM, by clicking the appropriate links (568, 572, and 576). A user may also review all the Rejected ideas in whole or by date by clicking links (578 and 582). A user may also launch software dashboard applications by clicking links (584, 586, and 588) or execute a customized search by clicking a link 592.

FIGS. 5D-5F are other exemplary user interfaces for a member of a New Product Council or PD team to review and manage a product idea in a product development process. FIGS. 5D-5F show parts of the same user interface. A user can scroll across a computer screen to view all the information on the user interface. FIG. 5D shows that a user can review a list of product ideas by name 501 on a user interface. The user interface can display the expected or actual launch date of each listed product idea by quarter 503. Further, the user interface can list the stage in which each product idea is in the product development process 505. In addition, the user interface can list the assigned RM for each product idea 507.

FIG. 5E shows the user interface listing the business unit associated for each product idea 509 and the Idea Identification number 511. Further, the user interface lists the region where the product may be marketed 513 and the New Product Champion for the product idea 515. In addition, FIG. 5F lists the Priority status in developing the product 517, the Potential Premium or revenue generated by the product 519, and the status of the product management 521. FIG. 5G shows another user interface that can be accessed by a member of the New Product Council or PD team that lists the same information as in FIGS. 5D-5F, but on one screen. A user can access the information shown on the user interfaces in FIGS. 5D-5F.

FIG. 6 shows a New Product Incentive program that may be part of a system for developing a product, according to an aspect of the system. A company may implement a New Product Incentive program to foster a creative corporate environment, and to recognize business unit employees that contribute to the New Product development process. Exemplary components of a New Product Incentive program may include monetary compensation for ideas accepted for development 610, ideas launched as products 620, and rewards for a financially successful product 630. The new Product Incentive program may be offered by the PD team or by each individual business unit. Experience has shown that business units that develop their own reward program generate the most productive new product ideas. In addition, some employees may be more motivated to generate new product ideas by non-monetary incentives. Examples of non-monetary incentives include a letter of appreciation from the business unit president 640, recognition in the business unit news letter 650, lunch with the business unit president 660, or a gift certificate 670.

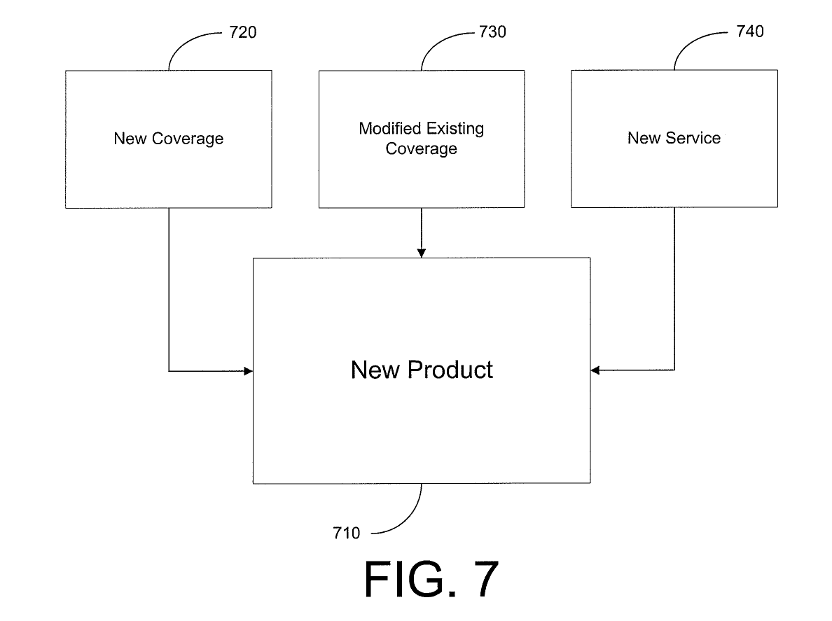

Once the infrastructure for product development is in place, a company can generate and gather ideas from its workforce that is spread across its diverse business units. Idea generation may be accomplished in several different ways. A company may provide different definitions of an idea that is worthy of being developed into a product and/or classify different product ideas into different categories. New product ideas may be generated by identifying trends in different markets as well as mining ideas from different resources from within the company and third party service providers. FIGS. 7-10 illustrate these different aspects of an exemplary idea generation stage of a product development process, according to an aspect of the invention.

FIG. 7 is a chart that shows exemplary definitions of a new product idea 710 in an insurance corporate environment, according to an aspect of the invention. Providing new product definitions may be a step within the Idea Generation stage of a product development process. The definitions focus company employees on the type of product ideas to generate for the company. A first definition of a new product idea 710 may involve new coverage or a combination of coverages not provided by a business unit in the past 720. A second type of new product idea may be existing coverage modified for a specific industry, region, customer segment, or distribution channel 730. A third definition may involve consulting, online, or technological enablement or other service that provides a measurable revenue stream either through a direct fee or increased sales of an existing product that is attached to the service 740.

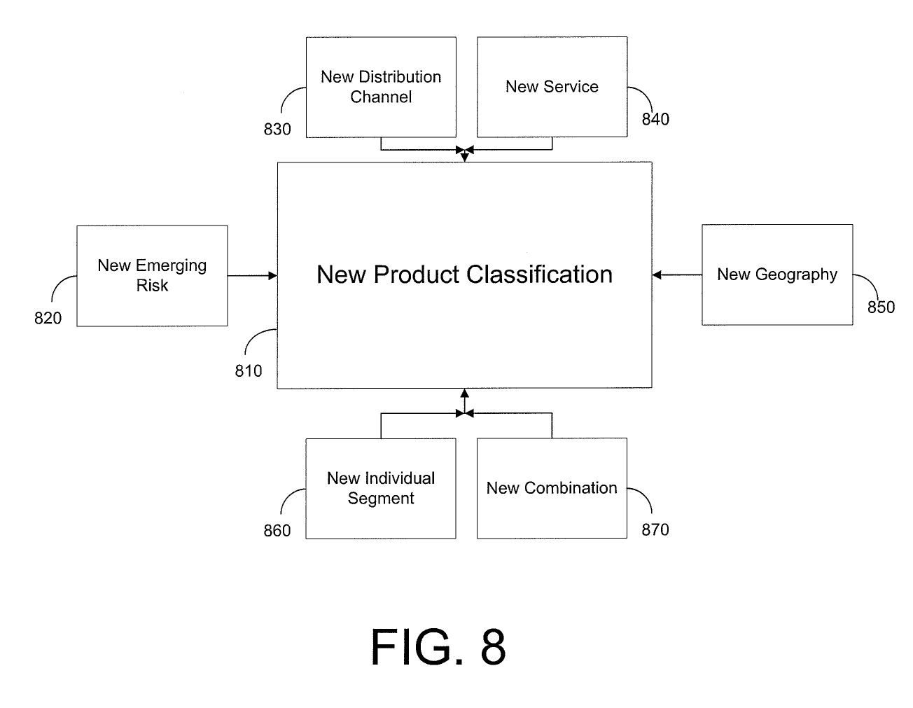

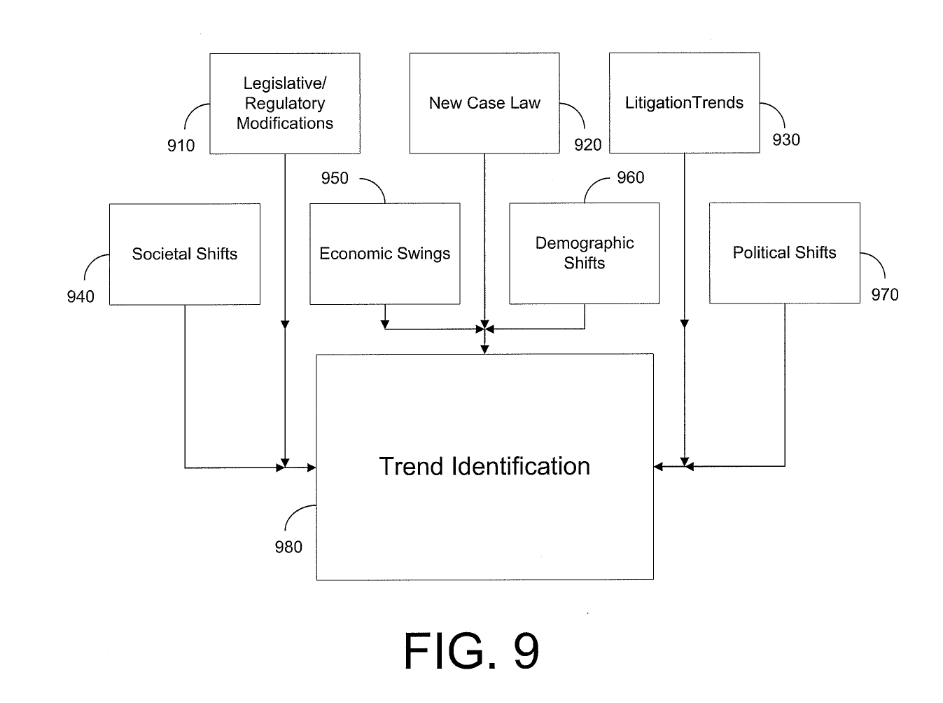

FIG. 8 is another chart that shows exemplary classifications of new product ideas 810 in an insurance corporate environment, according to an aspect of the invention. Similar to defining new products, classifying new products also focuses company employees on the types of product ideas to generate during the Idea Generation stage of a product development process. These classifications may include a new emerging risk 820, a new combination 870, a new geography 850, a new individual segment 860, a new distribution 830, and a new service development 840. A new emerging risk 820 may be a risk that arises in the market due to new trends in the insurance industry. Trend identification is discussed later in this disclosure when describing FIG. 9. A new distribution channel 830 may be a new technology that has arisen and offers a new avenue to offer insurance products. An example of a new distribution channel may be an insurance company offering its insurance products over the Internet. A new service 840 may be a certain service offered to an insurance customer in addition to, or instead of, an insurance product. An example may be psychiatric counseling to insured company employees when there is an accident on insured premises. A new geography 850 may be offering insurance products in different countries or regions of a country. New regulations adopted in a certain U.S. state may allow an insurance company to offer a new insurance product in that state. For example, a state may enact new legislation that requires taxi drivers to carry insurance for injuries sustained by their passengers if the taxi is involved in an accident. A new individual segment product idea 860 may be an existing insurance product that is offered to a new demographic segment. For example, offering disability to newly immigrated residents. A new combination 870 may be a unique combination of insurance products and/or services. For example, combining psychological counseling to an insured company with factory accident insurance.

FIG. 9 is another chart that shows exemplary trends that company personnel can identify to generate new product ideas in an insurance corporate environment, according to an aspect of the invention. Identifying global trends may be key in generating new product ideas. New insurance product ideas may emerge as a direct result of a change that creates a new or increased risk. Early awareness of these changes is referred to as Trend Identification and may be an exemplary step during the Idea Generation stage in the product development process of the disclosure. Therefore, the key to new product idea generation is keeping abreast of changes for early identification of trends. FIG. 9 shows several exemplary trends that include Political shifts 970, Legislative/regulatory modifications 910, New Case Law, Litigation trends 930, Societal shifts 940, Economic swing 950, and Demographic shifts 960. Identifying political shifts 970 may include recognizing that the political makeup of a country is changing from liberal to conservative such that insurance products catering to conservatives are more viable. For example, a company may determine that the political makeup of their customers is comprised of fiscally conservative people. Thus, an insurance company may develop financial products that have a guaranteed return on a customer's investment. Identifying Legislative/Regulatory modifications 910 may include offering products that comply with newly passed legislation or regulations such as the Sarbanes-Oxley Act. Understanding new case law 920 may include interpreting a new federal or state court decision and recognizing that it relaxes or newly regulates risk in an insurance market. Identifying litigation trends 930 may include recognizing several lawsuits filed against different potential customers are similar in nature but are not covered by an existing liability insurance product. For example, there may be an increased number of lawsuits against client corporations under the Sarbanes-Oxley Act, such that an insurance product may be developed to mitigate such a risk. Identifying societal shifts 940 may include understanding that more people are traveling such that they need travel insurance in view of the quality of airlines (lost baggage, flight delay, flight cancellation, etc.). Identifying economic swings 950 may be recognizing that more retirees are unable to afford long term care and offer such products to retirees' children to purchase for them. Identifying financial demographic shifts 960 may include recognizing that more people are retiring early so that a product providing higher rates of return on retirement benefits may be offered to such potential customers.

In order to stay aware of the trends in these key areas, the New Product Director and members of the Product Innovation Council utilize all of their internal and external resources as well as the PD team's resources. Internal Resources may include Department Employees, Account Executives, Claims, Marketing, Sales, Legal, Underwriting, and Senior Executives. External Resources include Producers/Risk Managers/Advisory Boards, Brokers/Intermediaries/Affinity Groups, Associations and not-for-profit organizations, Outside Counsel, and Trend Consultants (Think Tanks). PD team resources may include the product ideas stored within the ITAM computer system and the PD Relationship Manager.

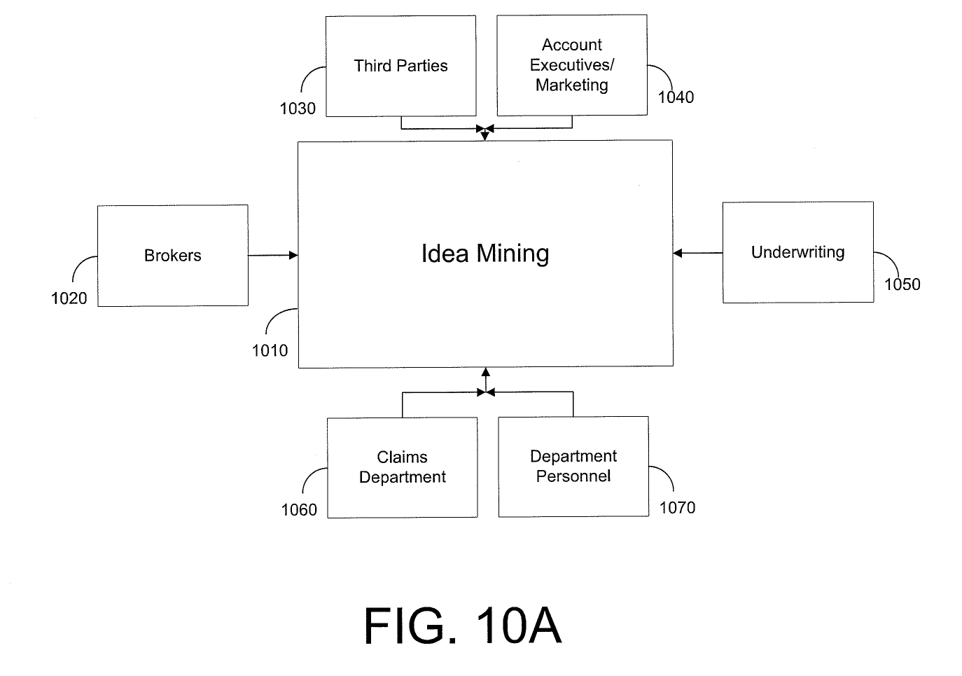

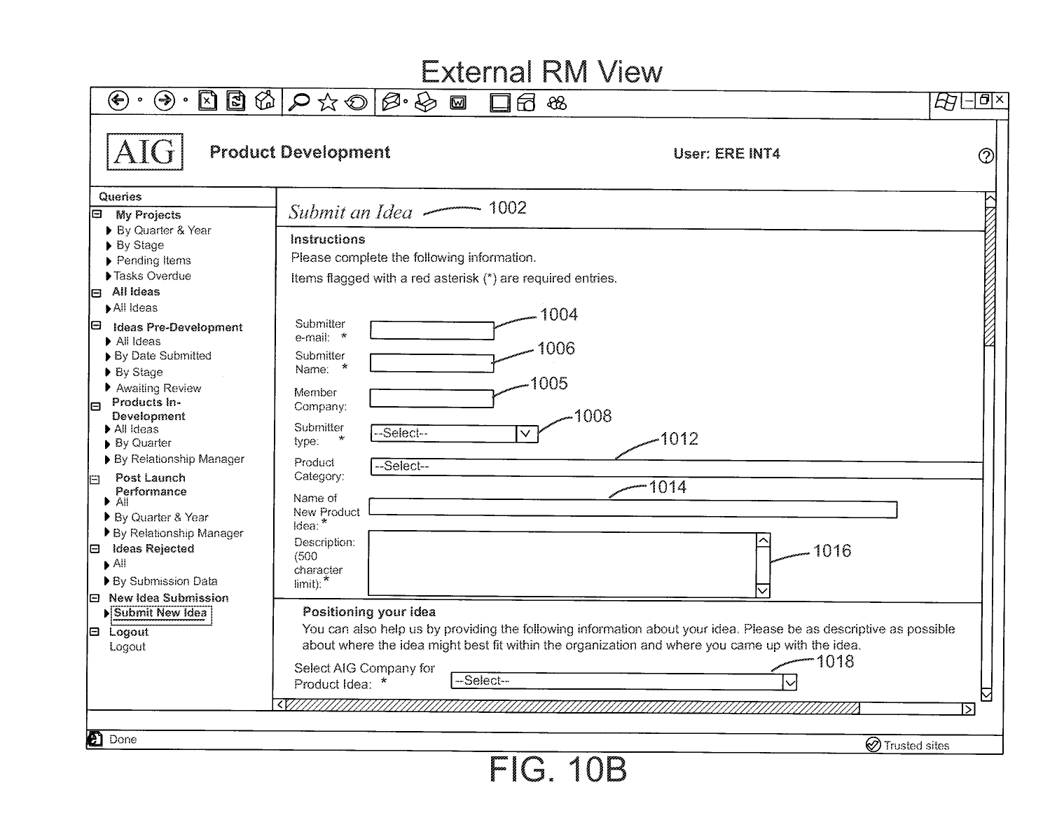

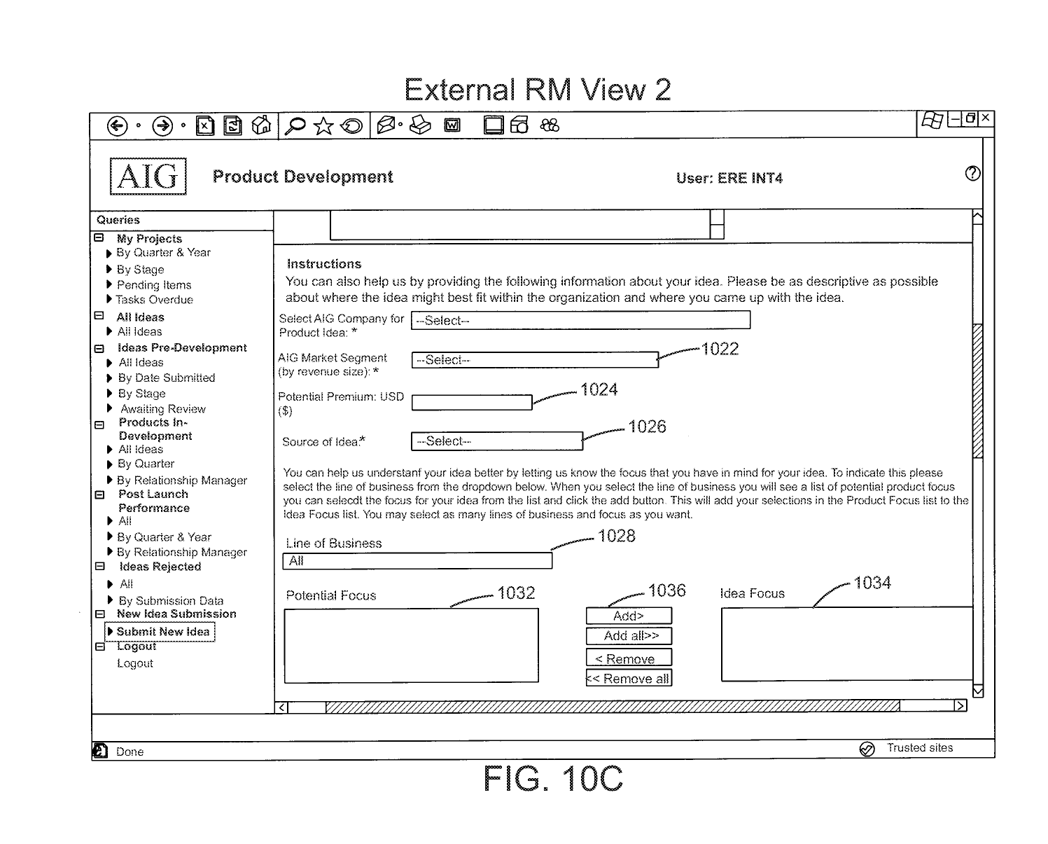

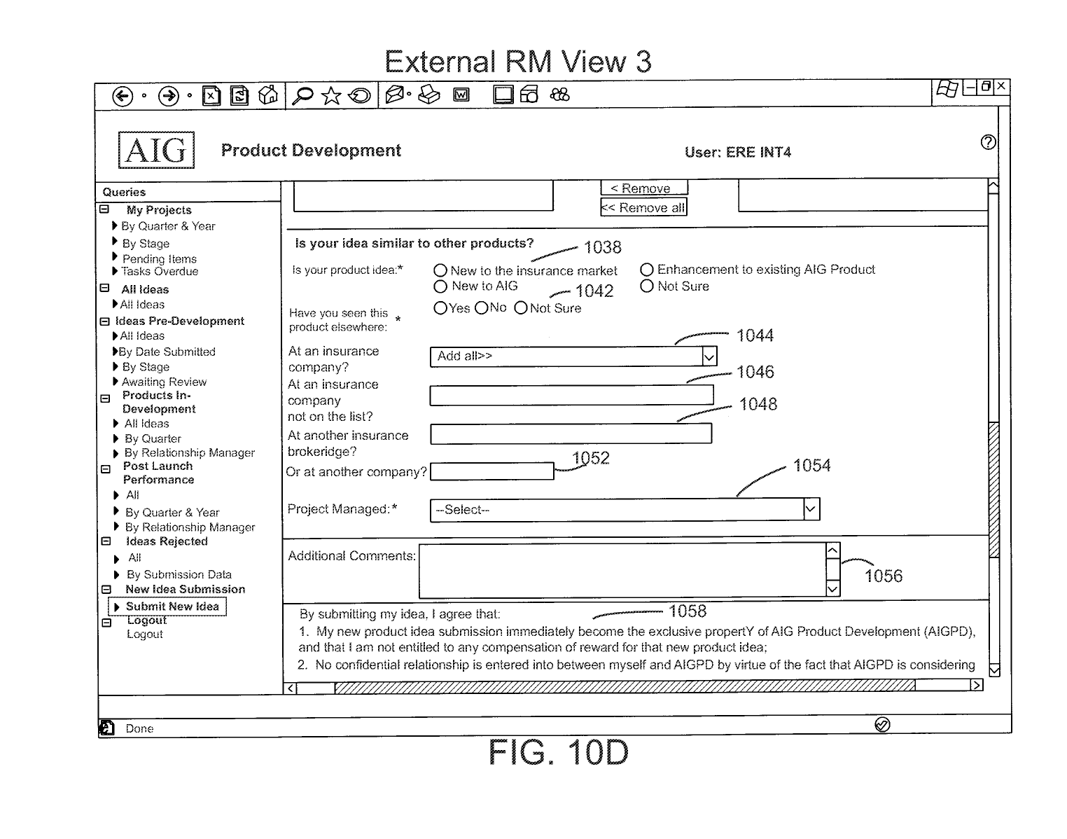

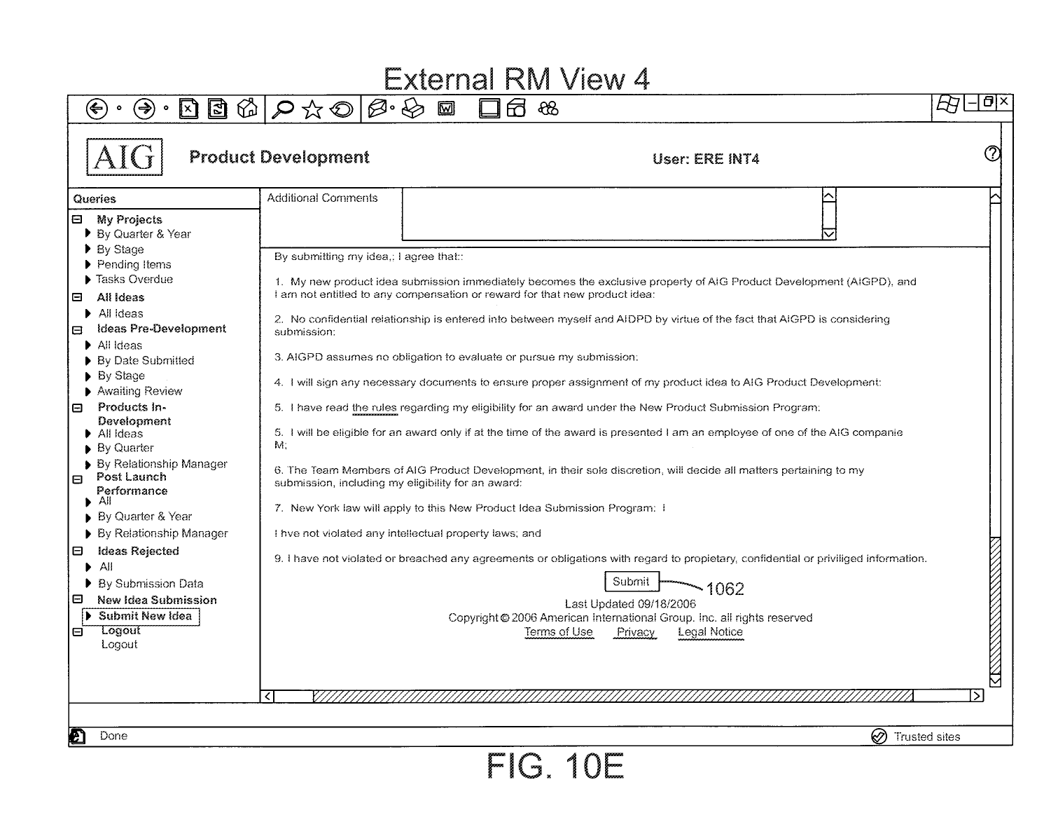

FIG. 10A is a chart that illustrates internal and external resources of a company that a company can mine for ideas as a step during the Idea Generation stage of the product development process. Idea mining 1010 means leveraging interaction with the resources to receive feedback on the changes in the insurance industry that are creating new or increased risk for the market. A business unit may receive feedback from Brokers/Intermediaries/Producers/Affinity Groups 1020, Account Executives/Marketing 1040, Underwriting 1050, Claims Department 1060, and Department Employees 1070. Feedback from Brokers/Intermediaries/Producers/Affinity Groups may include requests for new manuscript wording, discovering unmet and known risk needs, a group of clients with a unique need, and new products from competitors. Account Executives/Marketing/Underwriting feedback may include identifying competitors, replicating or improving competitors' products, and emulating similar products launched in other business units. A claims department may provide feedback on a new class of claims they are receiving, and new claims they are frequently denying. Department employees can identify current events, personal economic constraints, and personal risks to assist in generating product worthy ideas. All of this feedback from internal and external resources can be used by company personnel to generate new product ideas.

FIGS. 10B-10E are exemplary user interfaces that allow company personnel to submit a product idea into the ITAM computer system, according to an aspect of the invention. FIGS. 10B-10E all show parts of the same user interface. A user can access the different parts of the user interface shown in FIGS. 10B-10E by scrolling down the user interface. FIG. 10B shows the top of the user interface for submitting an idea into the ITAM computer system 1001. A user enters data into the appropriate fields so that the ITAM computer system can store the idea in an organized manner in its electronic databases. Subsequent users can then search for the submitted idea based on the data entered by the submitter. The submitter can enter his e-mail address, name and business unit affiliation in the appropriate data fields (1004, 1006, and 1005). The submitter may then select a submitter type (e.g., claim, actuary, underwriting, etc.) 1008 from a drop down menu. The submitter may then select a product category for the new product idea from a drop down menu 1008. The product may be the New Product classifications as shown in FIG. 8. The submitter may then enter a product name 1014 and a product description 1016 in the appropriate data fields. The submitter may then select a business unit to develop his product idea from a drop down menu 1018.

FIG. 10C shows another portion of the user interface that allows company personnel to submit a product idea into the ITAM computer system. A submitter may select a market segment for the new product idea from a drop down menu 1922. Further, the submitter may enter the potential premium or revenue for the product idea in a data field 1024. The submitter may then select a source for the idea from a drop down menu 1026. In addition, a submitter may select a line of business that is generated by the product from a drop down menu 1028. A submitter may also enter the idea focus 1034 from a list of 1032 using data control buttons 1036.

FIG. 10D shows another portion of the user interface that allows company personnel to submit a product idea into the ITAM computer system. A submitter may select the type of product idea 1038 and the source of the idea (1044, 1046, 1048, and 1052). The submitter may also select how the product development may be managed 1054 and provide any additional comments 1056. There is also a submission agreement for the submitter to review 1058. After reviewing the agreement, a user may submit the idea into the ITAM computer system by clicking the Submit button 1062 as shown in FIG. 10E.

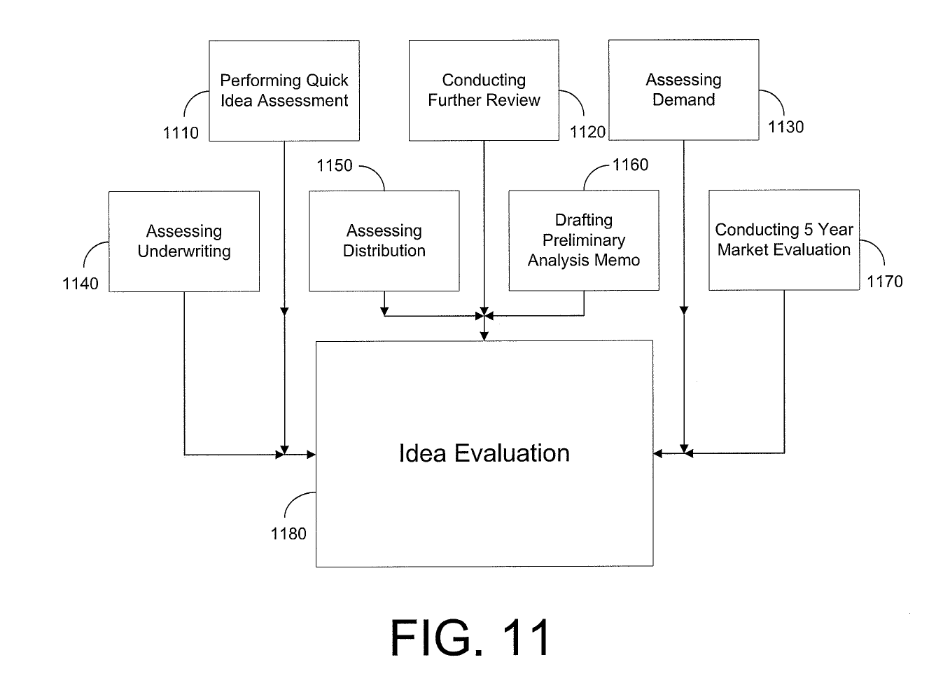

FIG. 11 is a flow diagram that shows exemplary steps in an Idea Evaluation stage within a product development process, according to an aspect of the invention. A review of all new product ideas in an insurance corporate environment may focus on three components of a successful and profitable insurance product, namely, Demand, Underwriting and Distribution. Demand requires that the new product idea have a large enough pool of potential clients with an anticipated high enough hit ratio to generate sufficient top line revenue. Underwriting requires that the new product idea can be written profitably. Distribution requires that the new product idea be one that can be sold through a channel that can effectively and efficiently reach the end customer. Idea Evaluation 1180 may include several different steps as shown in FIG. 11 such as performing a Quick Idea Assessment 1110; conducting further review 1120, assessing demand 1130, assessing underwriting 1140, assessing distribution 1150, drafting a Preliminary Analysis Memorandum 1160, and conducting a Five Year Market Evaluation 1170.

While performing a Quick Idea Assessment 1110, addressing certain fundamental issues can allow a business unit to quickly eliminate the ideas that are clearly not viable. Experience has shown that addressing the issues in Table 2 early in the evaluation process is helpful:

TABLE 2
Issues to Address in Quick Idea Assessment

| | |
|---|---|
| Determine whether the idea proposed is legal | Determine whether the idea is already |
| and whether it involves a legal activity for | addressed in the market by an insurance |
| which insurance can be used to mitigate the | product (if so, does the company offer this |
| risk | product already, if not, why; if so, can it be |
| | improved) |
| Determine whether the idea is an insurance | Determine whether the idea addresses an issue |
| product or related service | that occurs frequently enough to justify an |
| | insurance solution |
| Based on this assessment, determine whether it | Determine whether there is one or more |
| is best to assign the idea to another company | potential distribution channels for the product |
| business unit more suited to develop the idea | |
| into a product | |
| Determine whether this type of idea falls | Determine whether there is a fundamental flaw |
| within the company charter | in the risk analysis that makes the idea |
| | impossible to write profitably |
| Determine whether the company has a licensed | |
| subsidiary or affiliate that can underwrite the | |
| idea proposed | |

These issues are only exemplary and assist company personnel perform quick assessment of an idea.

Some of the ideas a business unit collects may fail the initial quick assessment. Some that pass may still lack the substance that would allow for a proper evaluation of their feasibility as an insurance product. As a result, a PD team or New Product council member may conduct further research and review 1120 of a new product idea. The type of research needed at this stage of the process is usually not extensive. It may generally include addressing the issues shown in Table 3.

TABLE 3
Issues to Address in Conducting Further Research

| | |
|---|---|
| Reviewing a copy of the law or | Reviewing the policy and marketing |
| regulation that form the | materials used by a competitor |
| basis for the idea | that offers the product |
| Contacting the submitter to | Contacting R&D to gather applicable |
| gather more details | articles and white papers |
| Contacting a sister business | |
| unit that writes similar type | |
| products to ascertain their | |
| opinion on the issue | |

Once research is gathered, it is reviewed with a focus on three components of a successful and profitable insurance product: Demand, Underwriting and Distribution. If the idea initially appears to have all three components, then a deeper quantitative demand assessment may be taken.

Many new product failures result from a lack of accurately assessing demand. The demand component of a new product determines whether the new product idea has a large pool of potential clients who are willing to purchase insurance to mitigate their risk. An accurate Demand Assessment 1150 at this early stage may include addressing the issues listed in Table 4:

TABLE 4
Issue to Address in Demand Assessment

| | |
|---|---|
| Defining the target universe | Conducting quantitative research on the |
| | distribution channel for this defined universe |
| | (the PD can assist with identifying select |
| | brokers, affinity groups or vendors to be |
| | surveyed by phone, mail or e-mail) |
| R&D resources can be used to research the | Summarizing the survey results (both the PD |
| relevant SIC codes, government census data | and R&D offer services to assist with the |
| and EMIS reports for the target universe | analysis of the survey data) |
| Developing a questionnaire to assess the | |
| accuracy of the defined universe (both the PD | |
| team and R&D can assist with the development | |
| of a questionnaire) | |

Frequently, a more detailed assessment of whether an insurance product can be profitably underwritten may need to be performed during the Idea Evaluation 1180 stage. This underwriting assessment determines whether the new product idea has enough credible data from which actuarial formulas can reasonably establish a rate. Obtaining the loss data needed for an underwriting assessment can be accomplished in a number of ways and some of which are listed in Table 5:

TABLE 5
Ways to Obtain Loss Data for Underwriting Assessment

| | |
|---|---|
| If the risk is the same as, or similar to, one | If the product is the same as, or similar to, |
| filed by the Insurance Services Organization | another product already in use by the company, |
| (ISO) those rates may be accessed through the | loss data is available from the sister business |
| Internet | unit |
| If a competitor has filed on an admitted basis a | |
| same or similar product, these fillings may be | |
| obtained from the state insurance department | |
| via the company's state filing and compliance | |
| department | |

Sometimes obtaining actual data information is difficult. In such a case, obtaining the underlying frequency and/or severity data is the most that can be accomplished, often from an Internet search or R&D. In all events, the statistical data on loss or rates along with the data on the target universe size are given to actuarial resources for an initial assessment of its adequacy for a rate determination. Alternatively, for new products, often the best that can be done is to analyze by best analogy by looking at the closest insurance product that data can be obtained. Generally, when doing this sort of analysis for an unusual and complex risk, it is advisable to use a research actuary. The PD team includes a research actuary with experience with the development of novel products.

Another step in the Idea Evaluation 1180 stage may include performing Distribution Assessment 1150 which involves determining the distribution channels that most effectively deliver the product to the target market. This may involve a detailed evaluation of the target market to understand customer buying habits and level of sophistication. For instance, when selling personal line products, business unit personnel should keep in mind that younger policyholders are increasingly price sensitive and technology-savvy, and usually want a variety of distribution channels including Internet, mobile text and instant messaging. (Alternatively, baby boomers prefer more traditional insurance channels. At most, they may check pricing on the Internet.) Some of the distribution options to consider include: Traditional broker; Agent; Direct marketing; Internet; Managing general agents (MGA); Program Administrators (PA); Banking relationships; Law firms, Accounting firms; Loss control or other service providers; Association or membership groups (sometimes as product “sponsors”).

In addition to a distribution assessment, a business unit may conduct a quantitative assessment that may include a Five Year Top Line Production Evaluation 1170 during the Idea Evaluation stage. In order to complete the Five Year Market Evaluation 1170, business unit personnel may have to use the statistical data gathered for a preliminary analysis memorandum, and make certain business assumptions using their experience with other similar products.

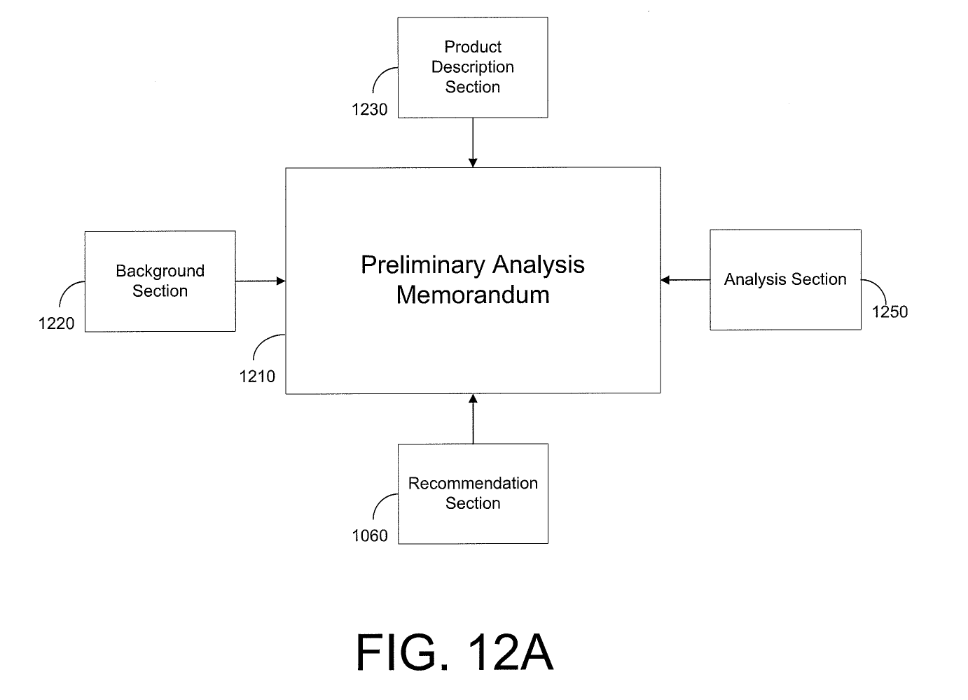

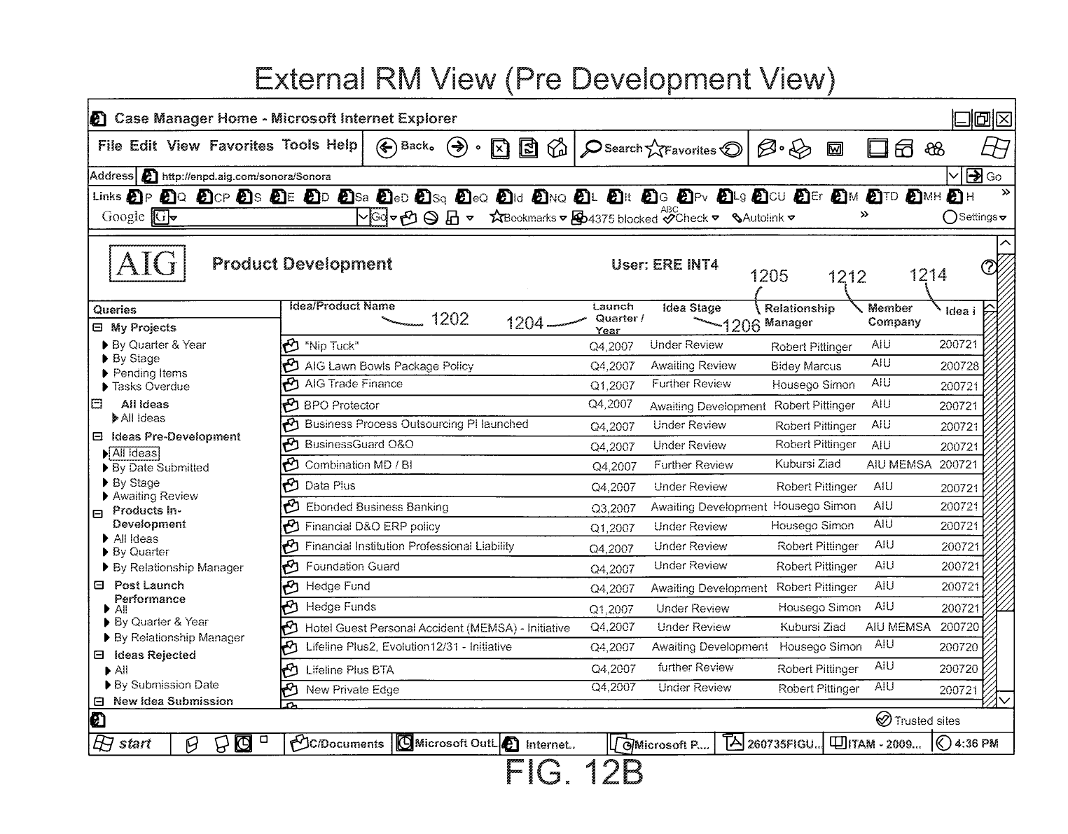

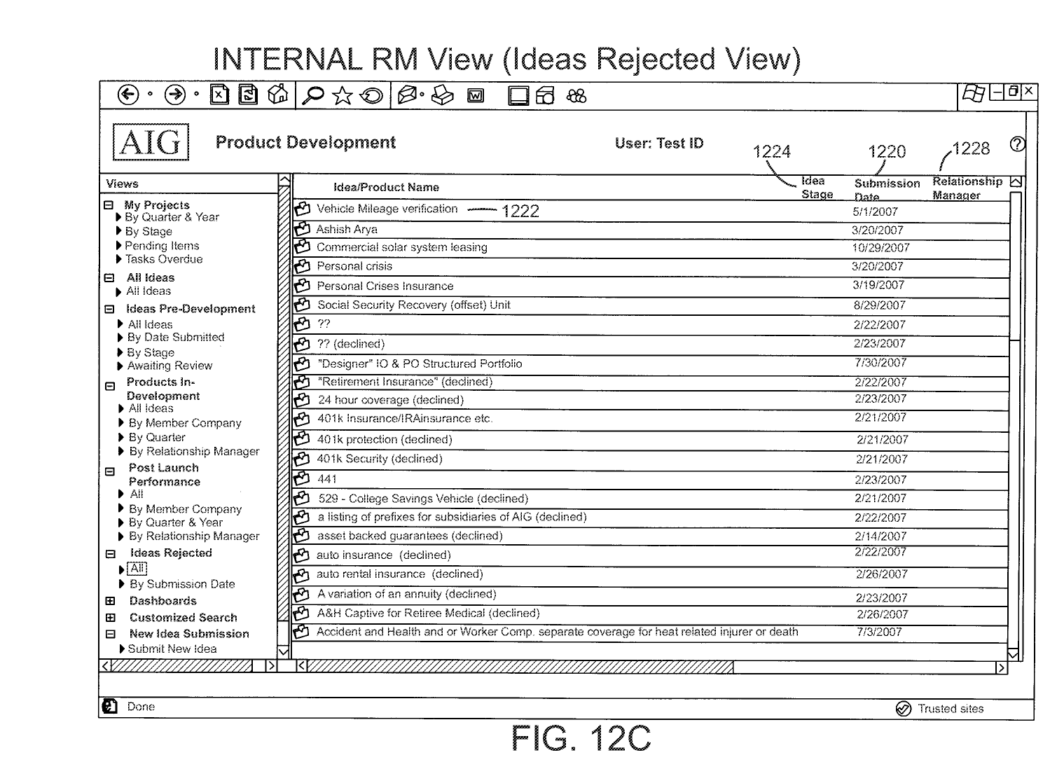

FIG. 12A shows exemplary parts of a Preliminary Analysis memorandum that is an exemplary component for a product development process, according to an aspect of the invention. The assessments of all three components of a successful and profitable insurance product, Demand, Underwriting and Distribution, should be documented in a formal or informal Preliminary Analysis memorandum so that it can be referenced in subsequent stages in the product development process. A Preliminary Analysis memorandum 1210 which comprises the following sections is shown in FIG. 12A: Background, Product Description, Analysis and Recommendation.

The Background section 1220 contains detailed information about the problem the product idea is supposed to address. This includes: description of the risk or problem facing potential insureds; the overall financial impact of the problem; the size and characteristics of potential insureds; R&D information from articles, legislation or industry journals that discuss the product idea; R&D statistical data gathered from the underwriting assessment; R&D data gathered from the demand assessment on the number of potential insureds that have the problem; any specifics about the geographic location or concentration of the problem; and any competitor analysis.

The Product Description section 1230 provides an overview of the insurance product design. It is not a comprehensive description of the policy. Instead, the Product Description section provides the means of addressing the fundamental elements of a product term sheet such as: incidents to be covered by the insurance product; the persons to be covered; product triggers; payment; exclusions; any major condition precedent to payment; and the limits, sub-limits and deductibles.

The Analysis section 1250 utilizes the information gathered from the Background and the Product Description sections to assess or summarize the resulting impact of background information on product demand, underwriting risk and distribution channels. Demand analysis includes the number of potential insureds and the financial impact of the problem large enough to create a demand that can justify the development of the product. Underwriting Risk analysis includes whether there is enough statistical data available to allow for a reasonable reliable actuarial assessment of the risk. Distribution channel analysis includes determining whether the product is best distributed through traditional brokers, DM or another third party, as well as accessibility of distribution channels and distribution costs.

The Recommendation section 1260 articulates whether the development of the product is recommended. It should be kept in mind that the Preliminary Analysis memorandum is given to business unit management for the initial approval to go forward with the development of the product. Therefore, a clear concise recommendation is important.

ITAM provides Product Council members to review ideas in a Pre-Development stage. FIG. 12B is an exemplary user interface that shows a list of product ideas in the Pre-Development stage. The user interface lists the product idea name 1202, the expected or actual launch date 1204, the current sub-stage the product idea is in within Pre-Development 1206, the RM assigned to each idea 1208, the business unit affiliated with the idea 1212, and the idea identification number 1214. FIG. 12C is an exemplary user interface that lists submitted ideas that have been rejected. The list includes the product idea name 1222, the current sub-stage the product idea is in within the Pre-Development stage 1224, the submission date 1226, and the RM assigned to each idea 1228.

A user can review the information listed in the user interfaces shown in FIGS. 12B-12C to review the status of new product ideas and manage their product development. For example, an RM may discover that the development of a particular product idea is behind schedule by comparing its submission date with its current sub-stage. The RM may then notify the PD team to add additional resources to the product's development so that it can remain on schedule.

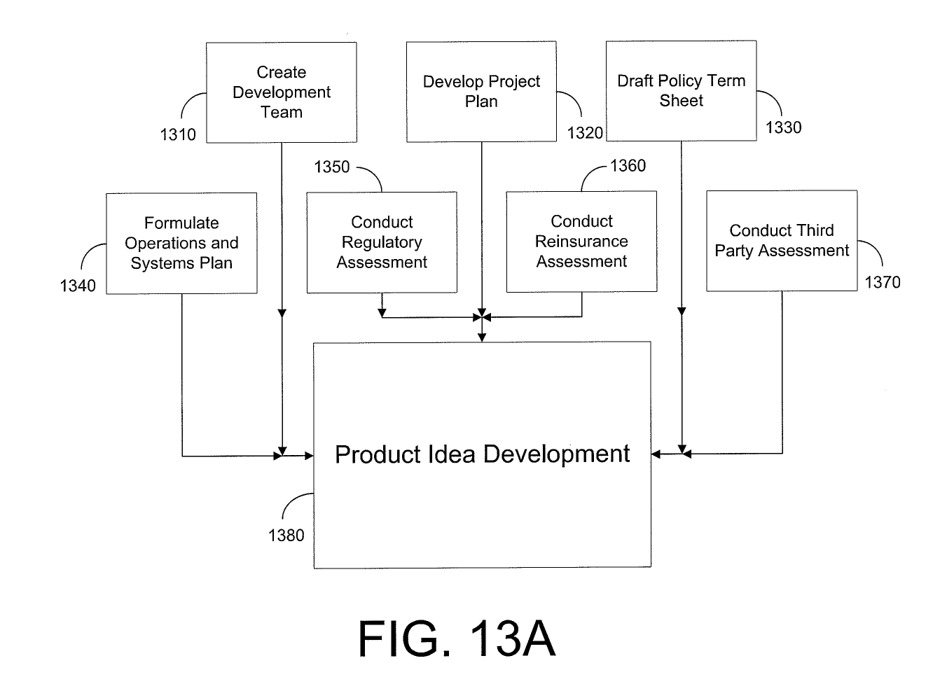

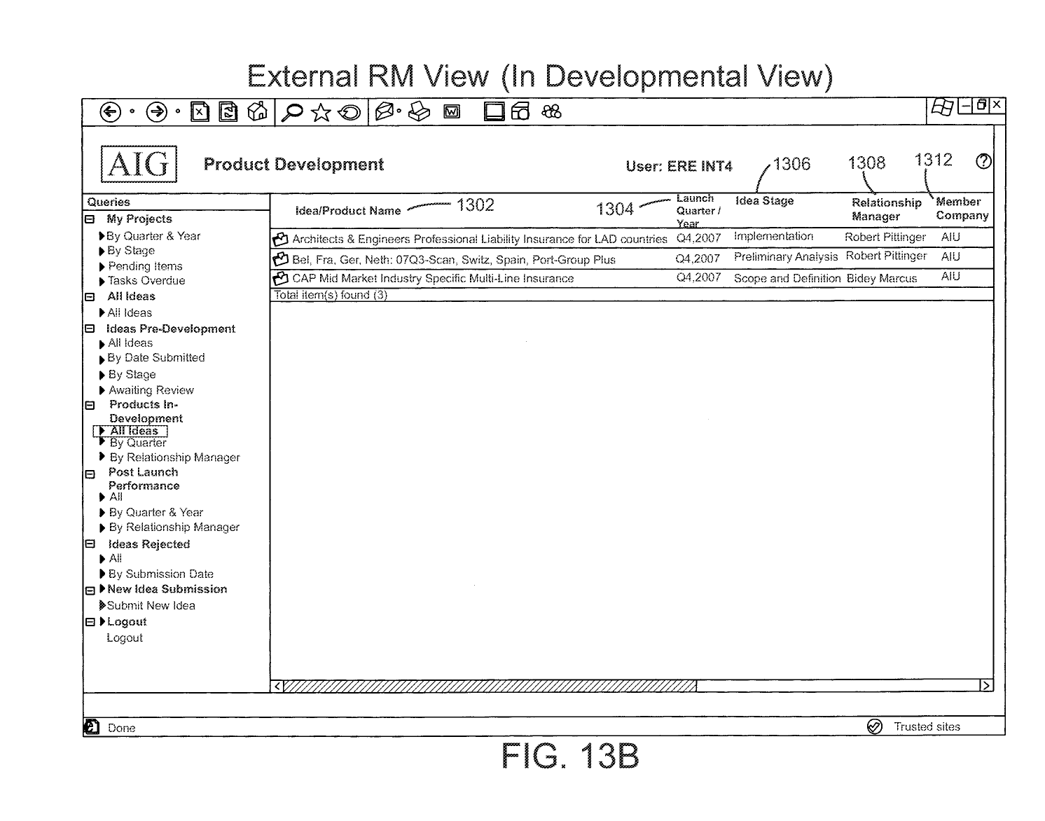

FIG. 13A is a flow diagram that shows exemplary steps in a Product Idea Development stage of a product development process, according to an aspect of the invention. Steps during the Product Idea Development 1380 stage may include creating a business unit development team 1310, developing a project plan 1320, drafting a policy term sheet 1330, formulating an operations and system plan 1340, conducting a regulatory assessment 1350, reinsurance assessment, and a third party assessment 1370.

It is recommended that the product development team include business unit representatives from the following areas: underwriting, legal, actuarial, claims, marketing and operations/systems. Regional Participation, where not essential, is often useful. Although the PD team is managing the development of the business unit's product and the PD team is assigning the business unit's resources within the PD to take a lead role in the development process, the business unit representatives provide oversight, feedback and final approval of any product development milestones.

In addition to creating a Development Team 1310, a Project Plan 1320 is developed. The development of a whole new product can be completed in as quickly as six weeks or take as long as two years. Developing a project plan is an important step in efficiently developing a new product. An approved project plan with definitive dates and assignments maintains the accountability of the team members and the efficient development of the product. An optional project plan tracks all the components for the development process, including product development stages, tasks and documents.

A time-consuming aspect of any new insurance product development is the drafting of the insurance policy 1330. When lawyers of the business are simply given a business plan or a set of vague instructions to draft an insurance policy for a new product, the process can result in multiple drafts and take months to finalize. This method is therefore unadvisable. Instead, in an effort to more efficiently streamline the process, business units to use a Policy Term Sheet. The term sheet acts like a detailed deal sheet. The Policy Term Sheet allows the team to outline and agree upon all of the important policy provisions before drafting the actual policy. The Term Sheet can also be used for endorsements that add another insuring agreement with new definitions and exclusions. This provides the business unit lawyers with more definitive terms and results in fewer policy drafts.

Operation and system planning 1340 are often ignored during the product development process and only addressed at or near the launch date. Consequently, operations and system problems can be a leading cause of new product delays. This can be avoided by including an operations and systems representative on the development team from the beginning of product development. All the operation and system issues can then be addressed early in the project plan. The operation and system issues that may be addressed include preparation of any BRD, assignment of a PUC code and scheduling a system release date. If the project plan includes the creation of a whole new system, even more extensive advance planning is required.

Many new insurance products involve new risks that are unusual and complex. Therefore, a regulatory assessment 1350 of the product should be performed early in the process. The project plan may include a section that captures the state filing and approval process.

New product risks are sometimes better served by the surplus line market, which is not subject to rate and form filing requirements. The surplus lines market has historically served as a proving ground for new products and underwriting concepts. Recent examples of new products beginning in the surplus lines market are employment practices, liability coverage and internet liability coverage. The rate and form flexibility of the surplus line market can provide a more creative and responsive market and should be considered. If a product is to be filed with a state, the following issues are determined: whether the product can qualify for rate flexibility through “A” rating or insurance risk rating; and whether the product can qualify for exemption under a “large risk” rule.

An early reinsurance assessment 1360 of the kind of limits that may be offered for the product and whether they may be taken can help avoid unnecessary product delays. If a product is offered under an existing reinsurance treaty, then a reinsurance meeting and approval process may be included in the project plan. Obtaining reinsurance approval can add an additional 30 days to the development process.

Third party vendors are a frequent source of new product ideas. However, third party vendors often add another level of complexity to the product development process and therefore are assessed 1370 during product development. It is always advisable to begin any third party vendor discussion by entering into a non-disclosure agreement. If the new product will include a service offered by the third party vendor, then an agreement detailing the service and any compensation to be paid will have to be finalized before the product is launched.

FIG. 13B is an exemplary user interface of the ITAM computer system that shows a list of product ideas in the In-Development stage of a product development process, according to an aspect of the invention. The user interface lists the product idea name 1302, the expected or actual launch date 1304, the current sub-stage the product idea is in within Pre-Development 1306, the RM assigned to each idea 1308, the business unit affiliated with the idea 1312, and the Idea Identification number. A user can review the information listed in the user interfaces shown in FIGS. 13B to review the status of new product ideas and manage their product development.

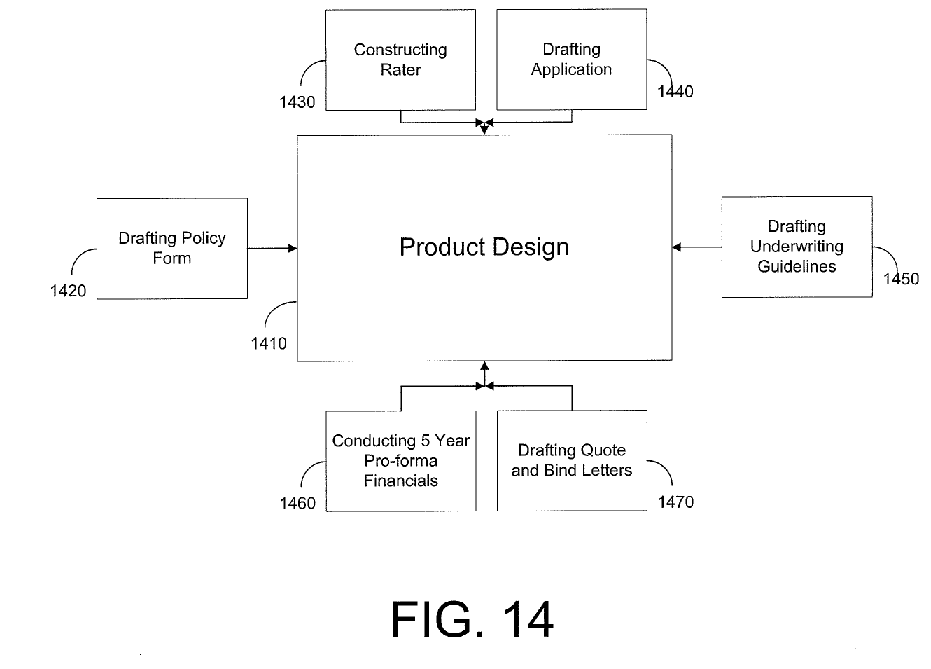

FIG. 14 is a flow diagram that shows the exemplary steps in the Product Design stage of a product development process, according to an aspect of the invention. Designing an insurance product includes drafting a policy form 1420, constructing a rater 1430, drafting an application 1440, drafting underwriting guidelines 1450, conducting five year pro-form a financials 1460, and drafting quote and bind letters 1470. Having a finalized policy term sheet that the product development team members have reviewed and approved makes the drafting of the policy form 1420 more efficient. If the policy needs to be translated into other languages, then the term sheet and structure of the policy is discussed with the regional attorneys before drafting the policy. Also, translation and regional review may be incorporated into the project plan as a result.

When creating a new rater 1430 the PD team and the business unit strive for a streamlined structure that allows the underwriters to quickly turn out quotes. Each new product is developed with an automated rater (e.g., spreadsheet) that is based on clearly defined rules and allows the underwriters to directly feed in the application answers. The rater is mapped to the policy application. A rater is consistent with underwriting and provides flexibility to ensure that artificial restriction does not prevent profitable deals to be bound. If the rater is to be incorporated into a new system, then planning is formulated and testing is performed. When dealing with an unusual and complex risk, it is advisable to use a research actuary. Actuarial considerations are listed in Table 6:

TABLE 6
Actuarial Considerations in Constructing a Rater

| | |
|---|---|
| Comparison of Proposed New Product to | Possible Application of Retrospective Rating |
| Existing Product or Products | |
| Determination of Exposure Base | Possible Application of Schedule Rating |
| Risk Classifications | Deductibles - Per Occurrence or Aggregate |
| | Basis |
| Expected Loss Cost (also known as Pure | Minimum Premium Requirements |
| Premium, “Burning Cost,” or simply Loss | |
| Cost) | |
| Commission, Taxes, and Other Expenses | Regulatory Acceptability Issues |
| Profit & Contingencies/Risk Charge | Consideration of Coverage Modifications to |
| | Bring the Rate into a Marketable Range |
| Rate-on-Line Approach or Basic Limits & | Reinsurance Considerations |
| Increased Limits Approach | |
| Possible Application of Experience Rating | Ease of Application by the Underwriter/Rater; |
| | Supportable Mathematical Underpinnings |

The policy application 1440 may be seamlessly integrated into the rater. This can be done by continually cross-referencing the application questions to the rater. Application questions usually gather information on the following impacts: Eligibility of risk application; Rate credit or debit; or Triggers exclusion or other condition. Questions which are designed for “gathering information for possible future use” and have no immediate impact on underwriting are used sparingly and only when there is a strong future value. If an application question does not directly relate to a variable in the rater then it should be eliminated. Both brokers and clients are more likely to solicit a quote for a new product if the application is user friendly and as short as possible (but convenient to underwriting needs). Therefore, the applications are designed to be easily accessible to brokers. For example, the application can be placed on an online platform and be integrated into a rater spreadsheet program. Alternatively, it may be stored as document.

For most products, detailed underwriting guidelines 1450 are developed for all new products. Underwriting guidelines can be used as a training tool for the underwriters and therefore are clear and user friendly. The Underwriting Resource Division (“URD”) product management group provides assistance with all new product development initiatives and the underwriting resources within a business unit should utilize their services as necessary. All of the components of the new product design are developed for a new coverage or combination of coverages not provided by the business unit in the past and are to be approved by URD before the product is launched. Therefore, it is recommended that the URD product line expert for a particular business unit be included as part of the development team for all new coverage or combination of coverages not provided by the business unit in the past.

All new product development is focused towards the creation of revenue producing profitable products. An assessment of a new product's profitability can be ascertained by conducting a five-year pro-form a financial 1460. Having a five year pro-form a assists a business unit with the ongoing monitoring of the new product's production goals after product launch. This pro-form a financial is more detailed than the simple top line financial developed in the earlier preliminary analysis stage of product development.

All too often the quote and binder letters are not addressed during the development process. This can lead to unnecessary delays. The quote and binder letters are a critical part of both the underwriting training and the final product broker validation. They may be prepared immediately after the policy draft is completed. Frequently a marketing promotion ranging from one paragraph to one page is included in quote letters when the product is new to the market.

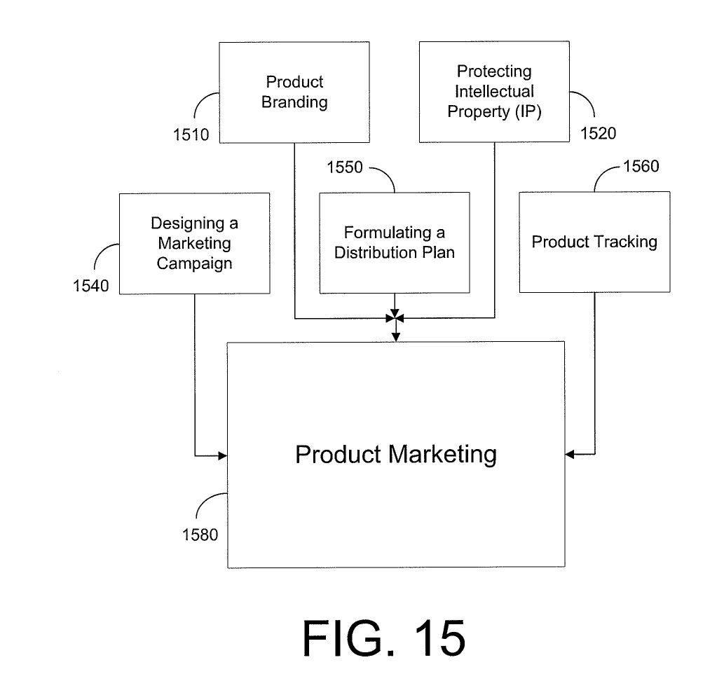

FIG. 15 is a flow diagram that shows the exemplary steps in the Product Marketing stage 1580 of a product development process, according to an aspect of the invention. Aspects of Product Marketing 1580 include Product Branding 1510, protecting Intellectual Property (IP) 1520, designing a marketing campaign 1540, formulating a Distribution Plan 1550, and Product Tracking 1560. Branding a new product properly is an important decision, and may lead to its ultimate success. Branding is designed to enhance the identity of the product through the use of any, or all, of the following: a unique brand name; a memorable image, graphic, or logo; a unique selling proposition (USP); and/or a differentiator among the competition. Therefore, considerable thought is given to the name of a new product. The product name should convey the message that a business unit wants brokers and insureds to remember. The right name can add considerable value to the new product when it is well recognized and detrimental to its success if it is not. The issues listed in Table 7 may be considered before selecting a product name.

TABLE 7
Issues Considered When Selecting a Name

| | |
|---|---|
| Determine what message does | Determine whether the product/ |
| the product/service convey | service have a tag line |
| Determine what are the key | Determine what will differentiate this |
| attributes of this product/ | product/service from that of |
| service | competitors |
| Determine who is the key audience | Determine whether the product be |
| for this product/service | an extension of an existing brand |

It is advisable to select more than one possible name for the new product, because during the due diligence process it may be discovered that one or more of the names are already in use and are unavailable. The Company Intellectual Property Group can assist business units with the due diligence process. In all new product ventures regarding name development, including, but not limited to domain names for Web sites, Intranet, etc., it is recommended that a business unit refer to the company branding guidelines.

During the product development process, a new product or business methodology may be subject to intellectual property (IP) protection 1520. Patent protection for new products is important in today's highly competitive marketplace. Current U.S. federal law potentially enables the insurance business to patent new business methodologies and products. Thus, it is important for companies to protect it in the design, underwriting, rating, claims processing, and management methods that are created during product development.

IP protection extends to many of the aspects of a new product, such as trade marking product names, copyrighting written materials, filing domain names and Web sites, protecting trade secrets, and submitting patent applications. A company Intellectual Property Task Force may be formed to assist business units with IP protection. The IP Task Force creates a consistent method of determining when a new product, process, or technology might qualify for a patent. This not only helps business units protect their valuable knowledge from being copied by competitors but also, by obtaining a patent, they may be able to generate revenue by licensing the IP. Therefore, before launching the new product Development team personnel notifies the company IP Task Force representative and begins the IP evaluation process.

The success of a new product often hinges upon the strength of its marketing campaign 1540. In order to ensure that all the marketing basics are covered, it is important that the marketing representatives on the product development team prepare a marketing plan and budget. The PD team can work with a business unit in developing a strategic marketing program for the new product. The PD team understands the various approaches necessary to launching a product and can collaborate with the business unit to make the product launch a success. In some cases, the marketing plan may address not only external communication, but also internal communication and Corporate Communications. Some of the features of the plan are listed in Table 8.

TABLE 8
Features of Marketing Plan

| | |
|---|---|
| PowerPoint presentation for broker/client | Article in InsuranceEdge, DBG's online broker |
| meetings, conferences, and events | newsletter |
| Talking points that highlight product features | Advertising in business publications (WSJ, |
| | NYT, FT, Business Week, Fortune, etc.), |
| | industry trade publications (Business |
| | Insurance, Risk & Insurance, etc.) and online |
| | banners |
| One page fact sheet and other marketing | Internet content |
| materials | |
| Brochure, detailing product information | Senior Level “Road Show” to promote to |
| | brokers/clients |
| Press Release to the trades and specific | Key theme at industry events, such as RIMS |
| industry | |
| Media Strategy to solicit articles and press | Support from various associations and third |
| mentions in major business publications | parties (i.e., U.S. Chamber of Commerce, III, |
| | etc.) |
| E-mail blast to entire broker database with link | White Paper, highlighting issues that the |
| back to Internet content | product addresses |
| Direct mail to brokers, risk managers, CFOs, | Press release |
| CEOs, Board Members, General Counsels | |

It is important that a budget be allocated to support a new product marketing campaign. The amount of the marketing budget and the extent of the marketing campaign may determine the results of the product's five year market evaluation and pro-form a financial assessment.

Once the distribution options for the new product have been decided, a distribution plan 1550 should then be formulated that outlines how to most effectively communicate and coordinate internal sales staff with the chosen distribution channel. The distribution plan serves as a roadmap for the sales force that complements the marketing plan.

One of the most important elements of a distribution plan for a new product is a well-organized and attended launch event. Keen attention is paid to the notification and timing of the launch event to maximize attendance. At times a “hard” launch with a formal launch event may be delayed or even eliminated in favor of a “soft” launch to select piloted brokers or a piloted jurisdiction. Product Tracking includes formulating a plan to monitor the progress of the product after launch.

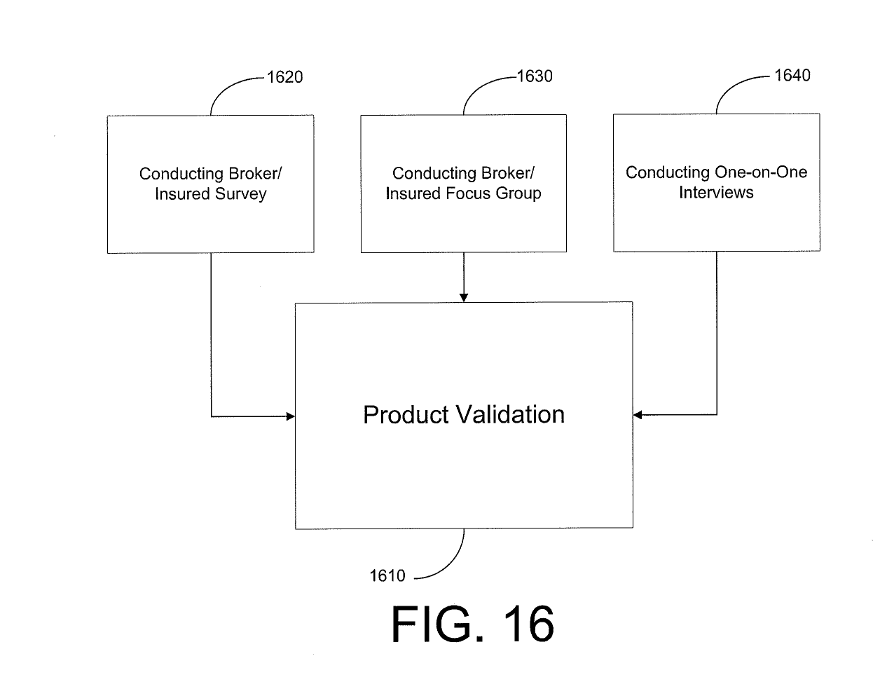

FIG. 16 is a flow diagram that shows the exemplary steps in the Product Validation stage 1610 of a product development process, according to an aspect of the invention. These exemplary steps may include conducting broker/insured surveys, broker insured focus groups, and one-on-one-interviews. The objective of a new product survey is to obtain quantitative feedback on the product features and demand. It is recommended that conducting a product survey be evaluated and conducted twice during the development process. An initial survey is conducted during the preliminary analysis stage to assist with idea validation and demand, and a more detailed survey is conducted after the design stage to validate the actual proposed product and features.

In order to ensure that a product survey provides precise and useful quantitative data, careful selection of those to be surveyed is critical. A possible listing of the various resources a business unit can use for a survey group is listed in Table 9.

TABLE 9
Resource for Survey Groups

| | |
|---|---|
| Broker Panels (any product) | Risk Manager Panels (any products) |
| Target Brokers (Industry specific | Employees (Personal Lines products) |
| products) | |
| Existing Insureds (Industry | Association Members (Industry Specific |
| specific products) | Products) |

The method used to administer the survey is also another important factor that may impact the type of survey group that will be used. A survey can be administered by mail, on-line, phone or Web based. Each has a different cost structure and the Five Year Product Market Evaluation assists business units in determining how much to invest in a survey. Once a survey group and method have been identified, the new product development team works with Corporate R&D which has the expertise and resources to assist business units with the design and implementation of the survey.

Another important element in any survey is the questionnaire. Careful attention should be given to the questionnaire design, including: definition of topics, concepts, and content; question wording and order; questionnaire length and format and the specific question response categories provided. Corporate R&D may assist with the questionnaire design as well as collect and analyze the results. The results from the survey are used to make idea assessments and fine tune final product features and marketing strategy.

While the primary purpose of a survey is to collect data to make product development decisions, surveys can and frequently should have a marketing impact. Questions can be added that are designed to illicit predictable insureds which are then turned into “marketing conclusions.” For example, “80% of company employees surveyed indicate a ‘need’ or ‘any need’” for this product.

Focus groups 1630 provide a different kind of analysis than survey results. In surveys, the emphasis is on counting and measuring versus the qualitative data of focus groups that allow a PD Team to penetrate the product features more deeply. Focus groups also allow a PD Team to obtain a wide range of information in a short period of time and the moderator can explore related but unanticipated topics as they arise in the discussion.

Focus groups are conducted by a trained moderator. Corporate R&D can provide trained moderators who are experienced with insurance products and provide a detailed summary of the focus group. The moderator's primary function is to keep the group “focused” on the product and generate a lively discussion of the product. The ideal size for a focus group is generally between 6 and 12 people. Focus group sessions are frequently scheduled to last two hours. Historically, broker focus groups are helpful with new complex combination products.

Surveys and focus groups are the preferred method for the most accurate assessment of new products. Often it may be difficult to get people to talk openly with others in the room, especially if they are competitors. In this case, then a One-on-One interview 1640 may be effective as long as careful attention is given to the development of the interview questions. This can be especially useful if the distribution of the product is through a MEA/PA or select piloted brokers.

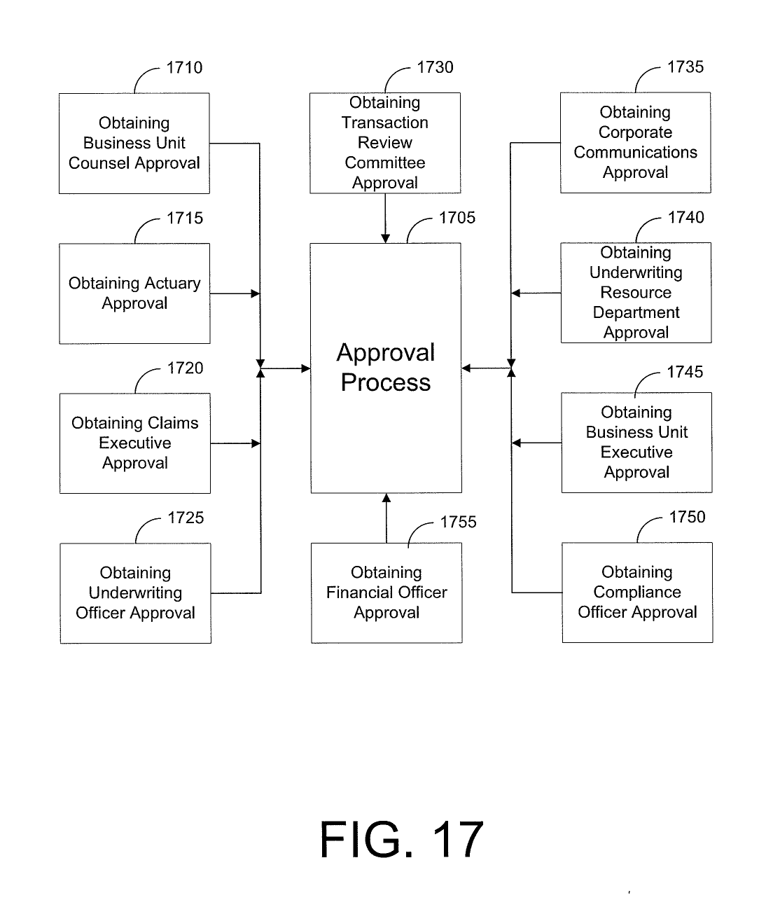

FIG. 17 is a flow diagram that shows the exemplary steps in an Approval Process stage 1705 of a product development process, according to an aspect of the invention. Each business unit may have a formal approval process that is followed before a new product can be launched. However, if the approval process is not documented, certain approvals maybe overlooked and lead to unnecessary delays. Therefore, it is essential during the product development process to identify and obtain approval from appropriate company personnel.

Business unit counsel 1710 approval may be needed to certify that the contract language affords the coverage designated by the underwriting and the product and all accompanying materials are reviewed and do not contravene any applicable law or regulation. Actuarial 1715 approval may be needed to certify that the rates are appropriately tailored and are reasonably expected to produce a profitable result. Claims Department 1720 approval may be needed to certify that claims are reviewed and input to the product has been provided. In addition, Claims Department interpretation may be needed so that the policy is consistent with underwriting intent. Underwriting officer 1725 may be needed to certify that the product is consistent with underwriting intent, underwriting guidelines have been reviewed and there is support for the product launch. Financial officer 1755 approval may be needed to certify that the product was reviewed and is reasonably expected to produce a profitable result. Further the financial officer needs to know any tax or accounting ramifications of the new product. Compliance officer 1750 approval may be needed to certify that the product, underwriting guidelines and business plan were reviewed and appropriately address applicable compliance regulations and laws. The business unit President's 1745 approval may be needed to certify that the product and all accompanying materials were reviewed, are acceptable and the product is reasonably expected to produce a profitable result. Underwriting Resource Department 1740 (URD) approval may be needed to certify that the product and underwriting guidelines have been reviewed and are acceptable. Corporate Communication 1735 approval may be needed to certify that the product and all accompanying external marketing materials were reviewed and are acceptable. All press releases may need corporate communication approval. Transaction Review Committee 1730 may also need to approve the product.

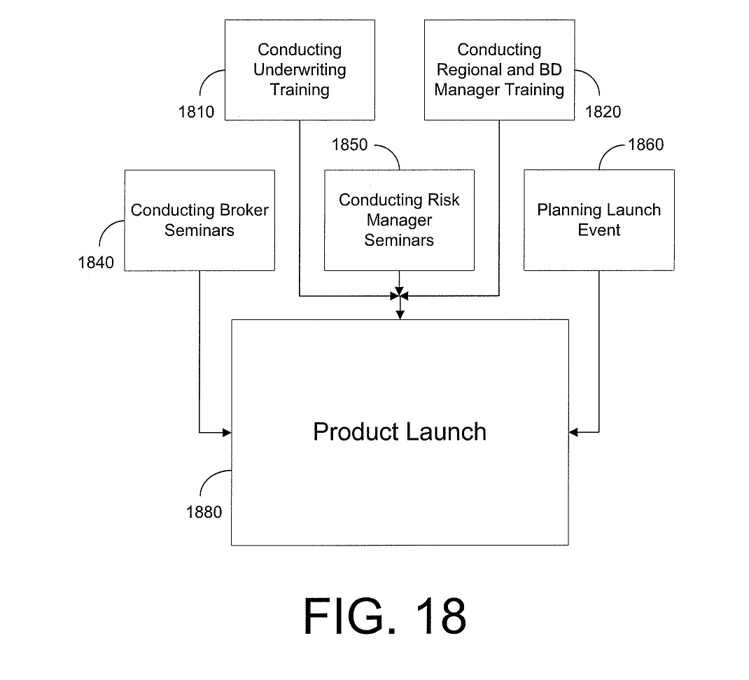

FIG. 18 is a flow diagram that shows the exemplary steps in a Product Launch stage 1880 of a product development process, according to an aspect of the invention. Launching a product involves conducting Underwriting Training 1810, Regional and Business Development Manager Training 1820, Broker Seminars 1840, Risk Manager Seminars 1850, and planning a Launch Event 1860.

Internal training is vital to generating excitement for and the early success of any new product launch. The underwriting staff is trained and aware of the new product offering, so that they can assist with the efficient execution of sales. The purpose of the underwriting training 1810 is to highlight the strategic importance of the product and to develop a high level of interest before the product is introduced to customers. The training includes a review of the following product items: policy form, underwriting guidelines, rater, application, binder and quote letter, all marketing materials and branding strategies and all systems related issues.

The PD team can work with a business unit in developing the training for the new product. The PD team has the experience with the various training approaches necessary to launching a product and can collaborate with a business unit to make the product launch a success. While on-site training is recommended, various approaches can take the form of a PowerPoint presentation, a webcast, video conference, or a conference call.

The regional and business development managers up to and including, Vice-President, Country President and segment lenders may be fully briefed on the new product so that they can plan and execute according to the external marketing plan 1820. Frequently, it is these individuals who receive the first phone calls from the brokers and insured community. Personnel are provided with copies of all the external marketing materials, including fact sheets, FAQs, talking points, press release, and presentations that highlight the product features and overall marketing strategy. It is important that the regional and business development managers training covers the issues listed in Table 10.

TABLE 10
Training Issues

| | |
|---|---|
| What was the risk | The target insureds for this product |
| problem to be solved | |
| Why the product is being | What new sales opportunities the new product |
| launched | provides |
| How the product fits into | How competitors may respond to the product |
| the business unit's | |
| overall strategy | |

The PD team has a Business Development Manager as part of its team who can to work with a business unit to develop and execute the training for the regional and business development managers.

Brokers are given the same careful attention and training that is given to the internal regional and business development managers. Brokers are trained so that they are completely knowledgeable about the product so that they are able to communicate enthusiastically with their insureds. Ideally, a business unit has already received input from some brokers during the final product validation process and, therefore, the product has the features the brokers suggested and recommended.

A full product briefing can be provided at a Broker Seminar 1840. This could be as simple as a morning breakfast or a mid-day lunch and learn. Insurance companies are not only “competing” for the brokers' time, but also all new products have to fight for the broker's attention. Therefore, it is important to provide the brokers with a pre-launch marketing communication to create momentum and interest in the broker seminars. Alternatively, one-on-one updates can be given during a scheduled broker meeting, a webcast, video conference, or conference call. The PD team can work with a business unit to develop and execute these broker seminars.

In addition, external marketing is directed to risk managers. Risk Managers are client employees that are in charge of mitigating risk and buying insurance for a company's corporate clients. A business unit can offer risk manager seminars 1850 on the new product. These seminars can be focused on the risk managers for the new product target industries. These seminars can be conducted separate from or in conjunction with brokers, law firms, or risk manager associations.

There exists a myriad of formats for a new product launch event 1860. A new product can be launched to all brokers at a single national event or at a series of regional and local events (“road shows”). Alternatively, the new product can be introduced to individual brokers through a series of sales calls or conference calls, or by sending mailings to individual brokers.

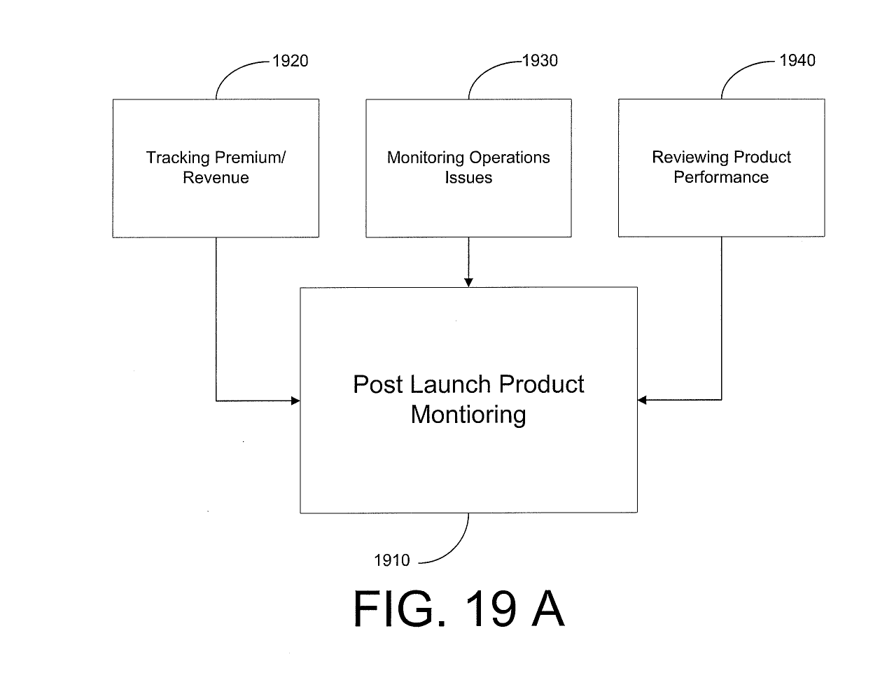

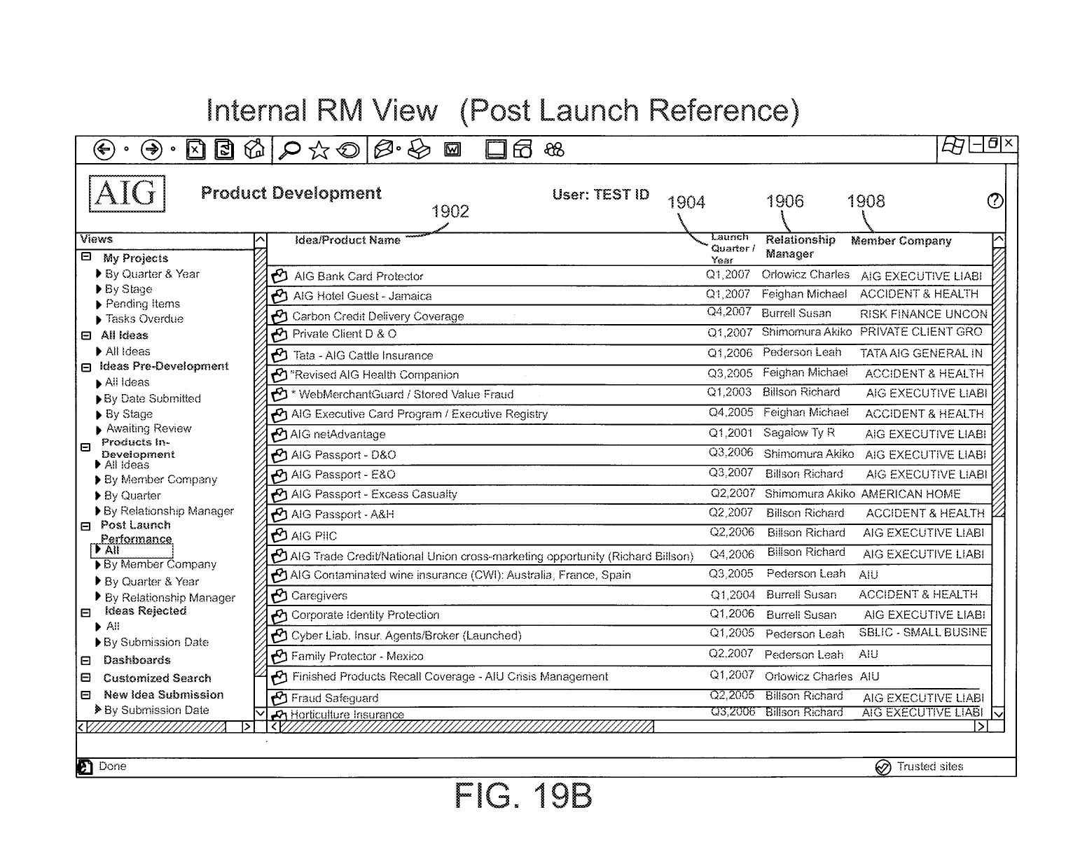

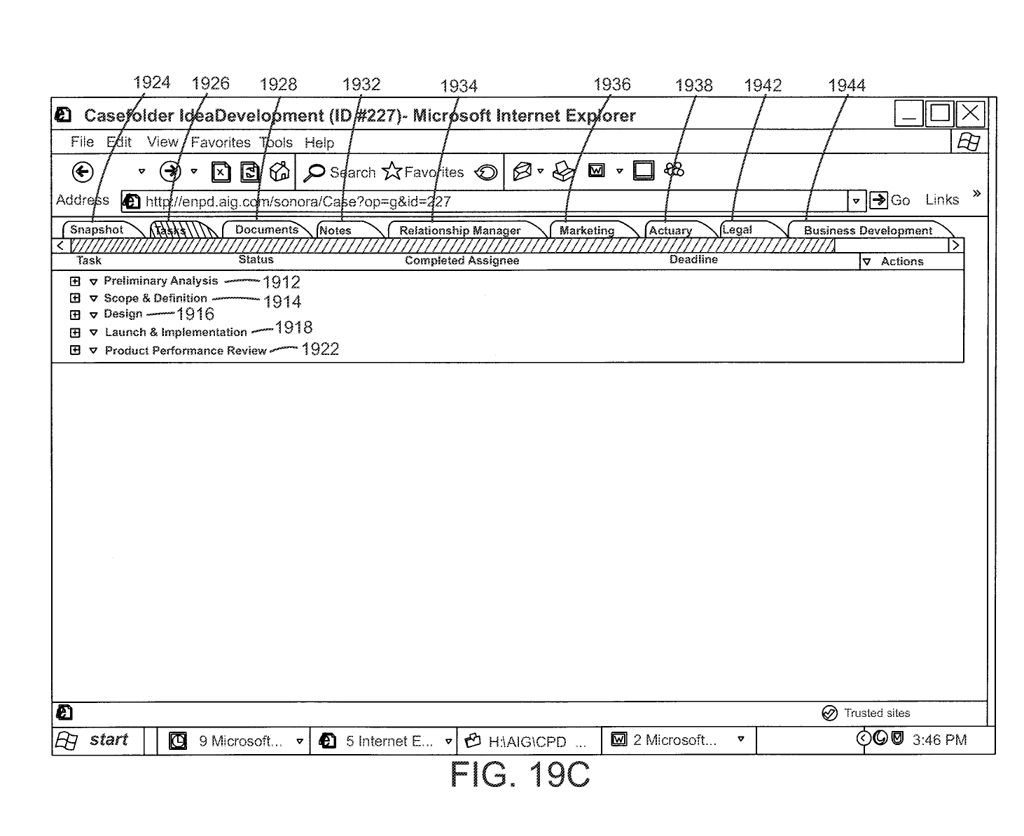

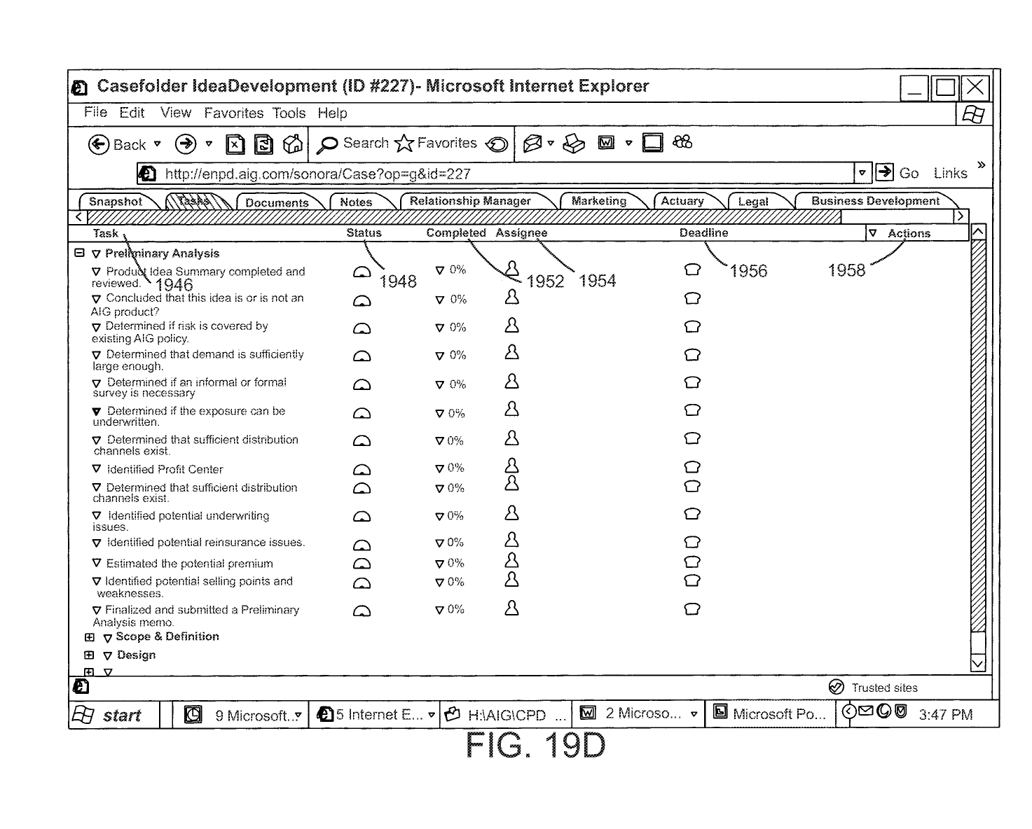

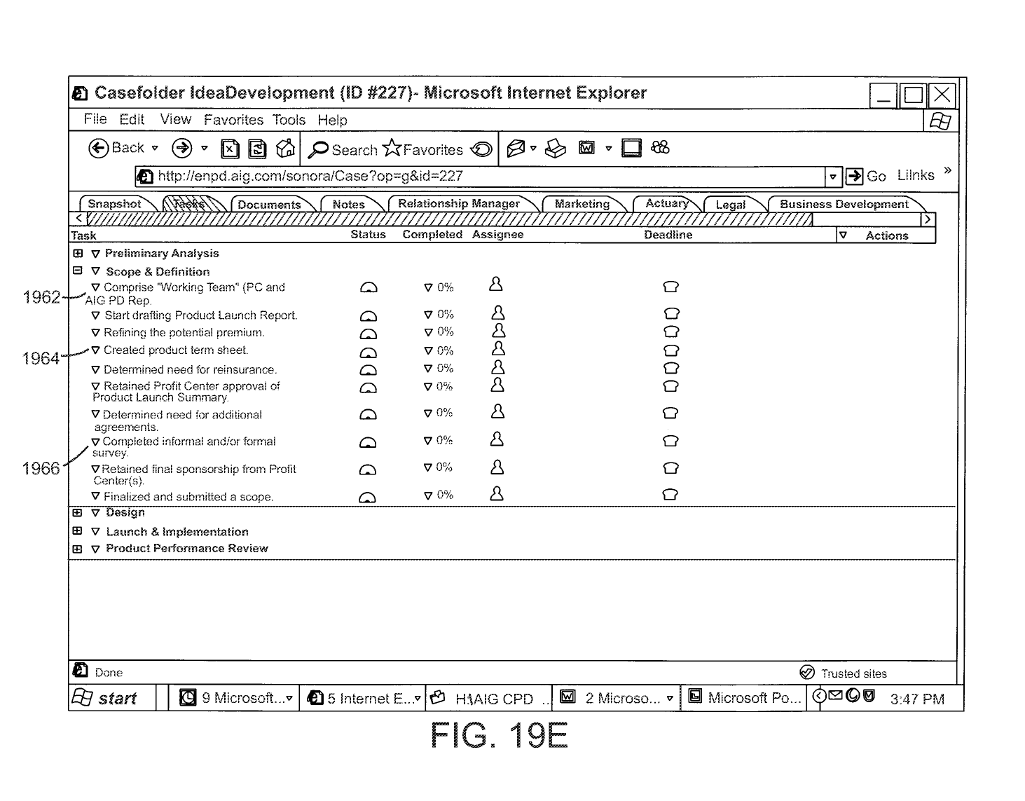

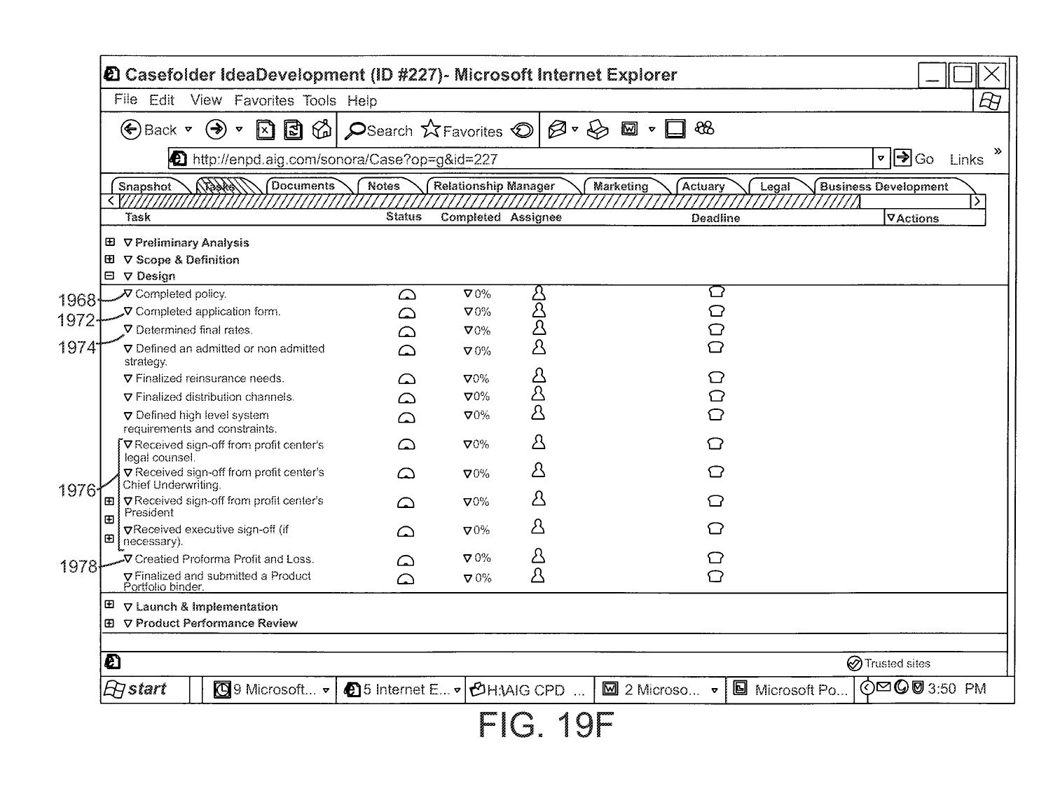

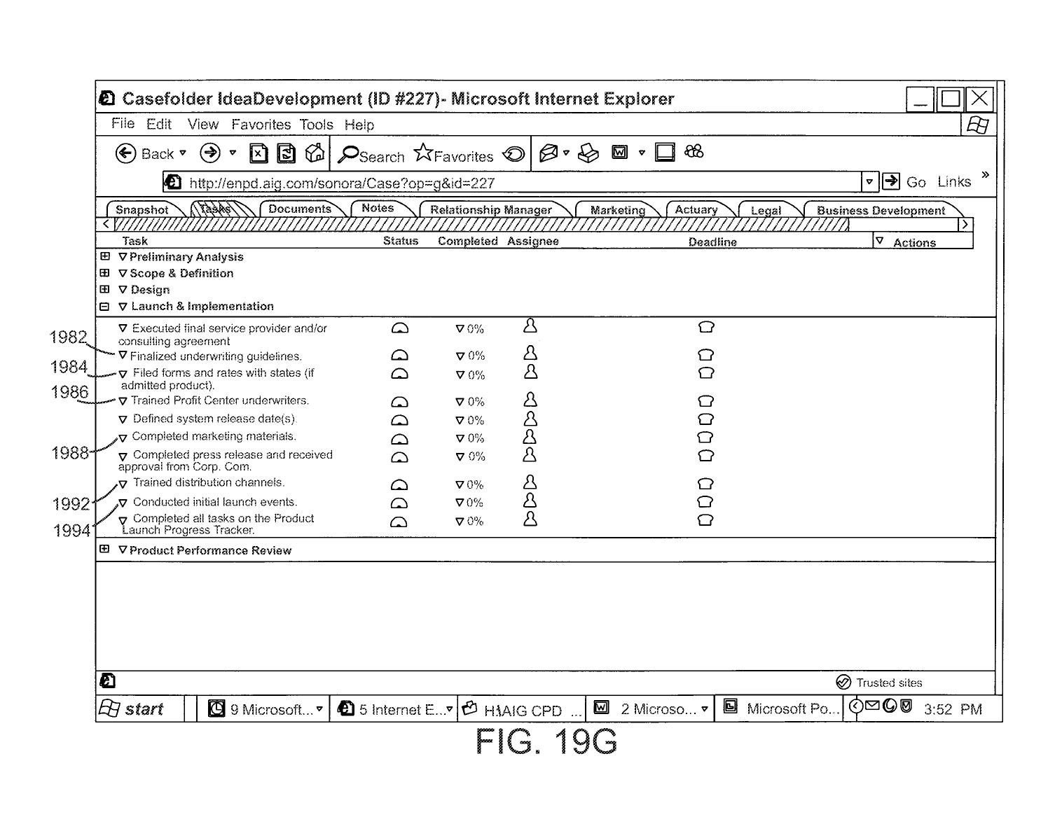

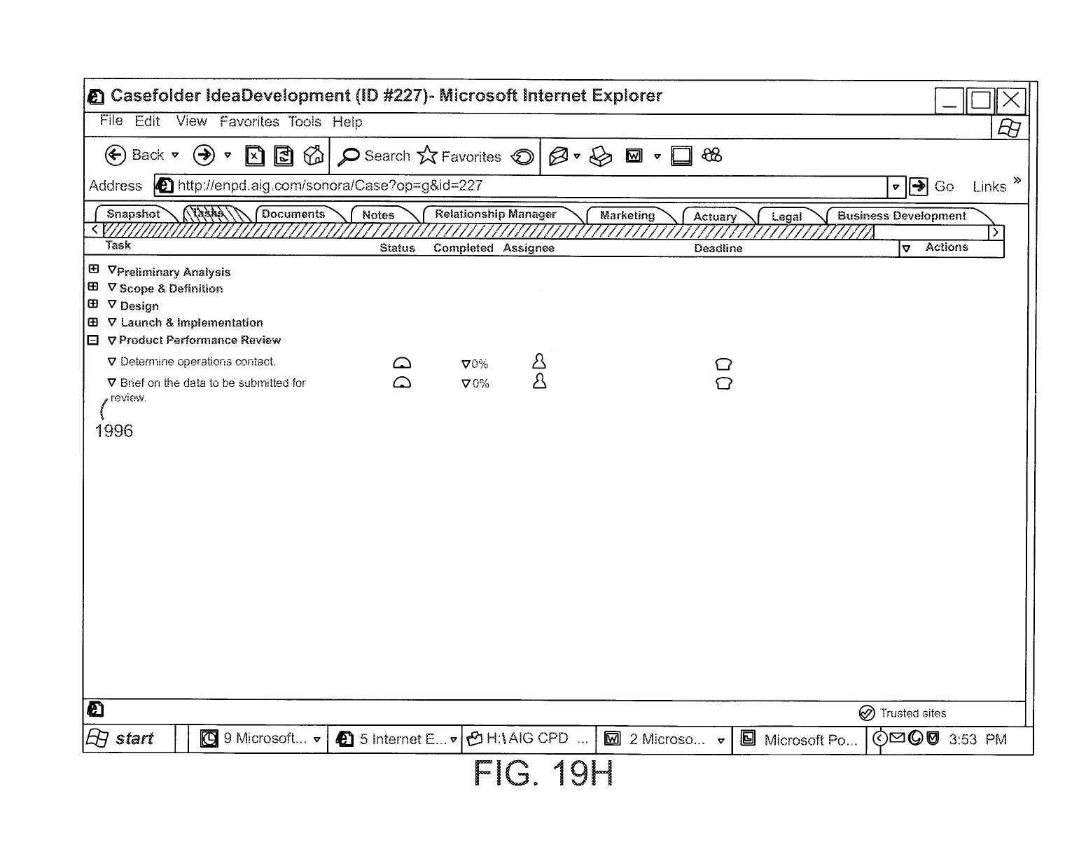

FIG. 19A is a flow diagram that shows the exemplary steps in a Product Monitoring stage 1910 of a product development process, according to an aspect of the invention. This includes tracking premiums and revenues 1920, monitoring operations issues 1930, and reviewing product performance 1940. All new product development is focused toward profitable products and therefore, accurate premium tracking is an essential part of the new product development process. The PD team works with the Comptroller to maintain and update the official list of all new products for a five year period and the premium(s) they have generated. This premium data is reviewed and analyzed to ensure that the company is on track to reach and exceed the corporate goals for new product production. The primary revenue and profitability can be compared to the product's five year pro form a financial created during the development process.

It is important that when a new product is being established in corporate IT systems that the operational mechanisms to track the premiums are put into place. If the proper tracking mechanisms are not put in place, then it can lead to inaccurate premium data and a lot of wasted time manually tracking premiums. This may mean the creation of a separate PUC code, OGIS code, or major/minor class code for the new product.

New products need to be tracked not only in terms of sales and profit, but also in terms of customer adoption and marketing execution, so necessary adjustments can be made to the product and marketing strategy. The PD team's list of services includes a product performance review that takes place at three, six and twelve months after launch.

ITAM provides Product Council and PD (corporate and business unit) members to review ideas in a Pre-Development stage. FIG. 19B is an exemplary user interface that shows a list of product ideas in the In-Development stage. The user interface lists the product idea name 1902, the actual launch date 1904, the RM associated with each idea 1906, and the business unit affiliated with the idea 1908.

FIG. 19C is a user interface that allows a user to review the tasks for each product idea in every stage of the product development process. The user interface has several tabs that allow a user to see a snapshot view of the product ideas 1924, the tasks for each product idea 1926, the documents associated with developing each product idea 1928, any notes for developing a product idea 1932, the RMs associated with each product idea 1934, as well as Marketing, Actuary, Legal and Business Development view of the ITAM system containing ideas that are being developed into products. The user interface also lists links to product ideas that are in different stages of the product development process including the Preliminary Analysis stage 1912, a scope & Definition stage 1914, a Product Design stage 1916, a Launch and Implementation stage 1918, and a Product Performance Review stage 1922.

FIG. 19D is an exemplary user interface that lists the tasks of product ideas in a Preliminary Analysis stage 1946. The user interface indicates the status of each task 1948, the percent completed 1952, the person assigned to the task 1954, the deadline for the task and any actions to be carried out for the task 1958. FIG. 19E is an exemplary user interface that lists the tasks of product ideas in a Scope & Definition stage. Some of the tasks listed include formulating a working team 1962, creating a product term sheet, and completing formal and informal surveys 1966.

FIG. 19F is an exemplary user interface that lists the tasks of product ideas in a Product Design stage. Some tasks include completing a policy 1968, completing an application form 1972, determining final rates for the product 1974, receiving approval from various departments 1976, and creating pro form a profit and loss financials 1978. FIG. 19G is an exemplary user interface that lists the tasks of product ideas in a Launch & Implementation stage. Some of the tasks listed include finalizing underwriting guidelines 1982, filing state regulatory forms 1984, training business unit underwriters 1986, completing marketing materials 1988, training distribution channels 1992, and conducting initial launch events 1994. FIG. 19G is an exemplary user interface that lists the tasks of product ideas in a Product performance stage where the user interface lists tasks including brief information on data to be submitted for review 1996.

A user can review the information listed in the user interfaces shown in FIGS. 19B-19G to review the status of new product ideas and manage their product development. An RM user can review the information provided on the user interfaces and, for example, contact persons assigned to overdue tasks and encourage them to complete the tasks in a timely manner.

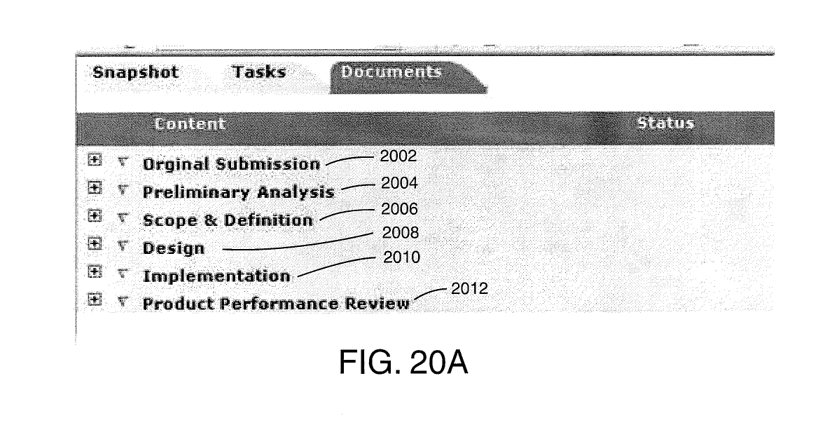

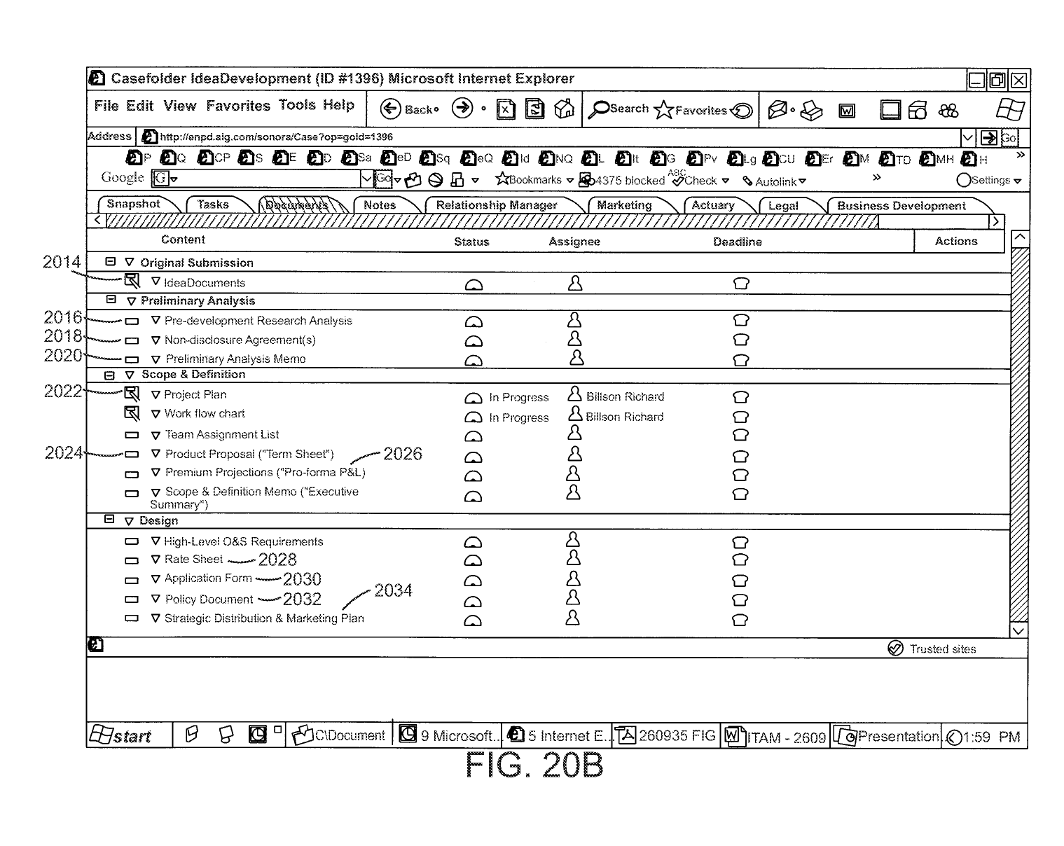

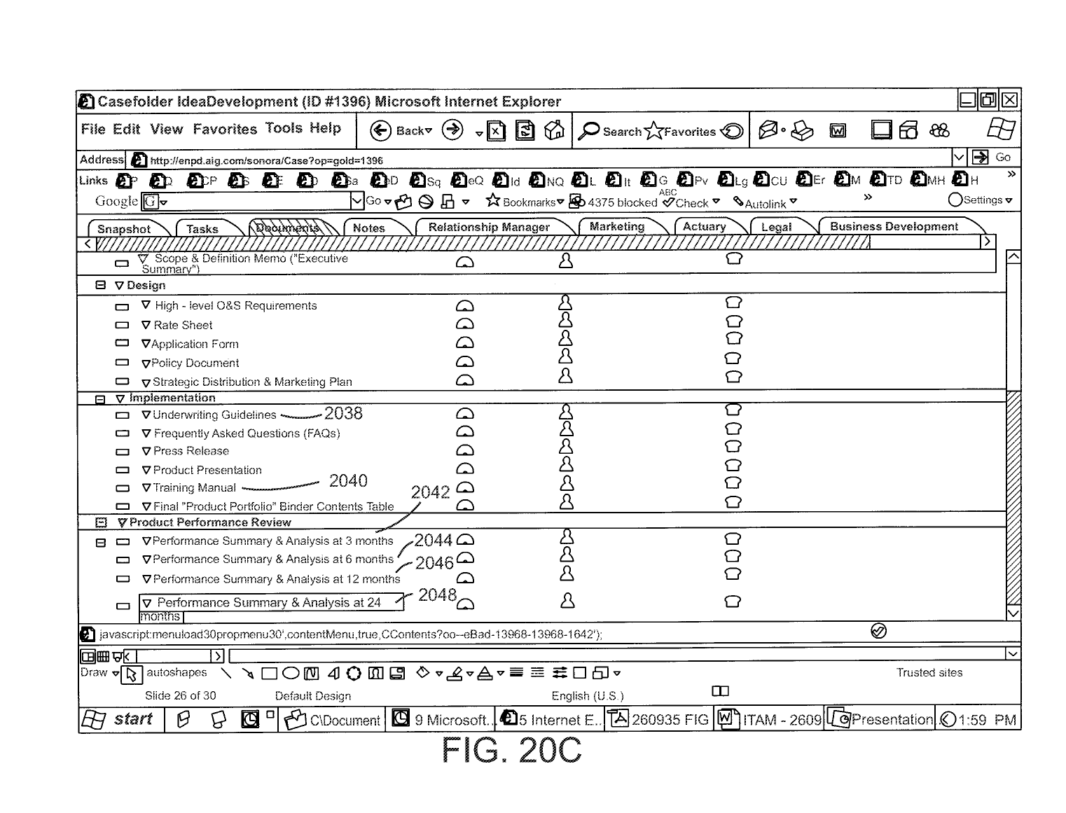

FIGS. 20A-20C are exemplary user interfaces that list the documents or other work product that are listed for each product idea during each stage of the product development process. Links are provided on the user interface to allow users to review documents and other work product for ideas that are currently in or have been in an Original Submission stage 1002, a Preliminary Analysis stage 2004, a Scope & Definition stage 2006, a Product Design stage 2008, a Launch and Implementation stage 2010, and a Product Performance Review stage 2012.

FIG. 20B is an exemplary user interface that lists documents and other work product for different stages of product development. This includes Original Submission documents 2014 as well as a Pre-Development Research Analysis document 2016, a non-disclosure agreement 2018, and a Preliminary Analysis memo 2020 in a Preliminary Analysis stage. The user interface also allows access to a project plan 2022, product proposals (term sheet) 2024, and premium projections (pro form a profit and loss) 2026 in a Scope & Definition stage. In addition, the user interface allows access to a rate sheet 2028, application form 2030, and policy document 2032, and a strategic distribution and marketing plan 2034 in a Product Design stage.

FIG. 20C allows a user to access underwriting guidelines 2038 and a training manual 2040 in a Product implementation stage. The user interface also allows access to performance summary analysis at 3 months 2042, 6 months 2044, 23 months 2046, and at 24 months 2048 in a Product Performance Review stage.

A user can review the information listed in the user interfaces shown in FIGS. 20A-20C to review the status of new product ideas and manage their product development. For example, an RM can access and review certain work product listed on the user interfaces to determine work product quality and to notify persons downstream of the product development process to complete their tasks.

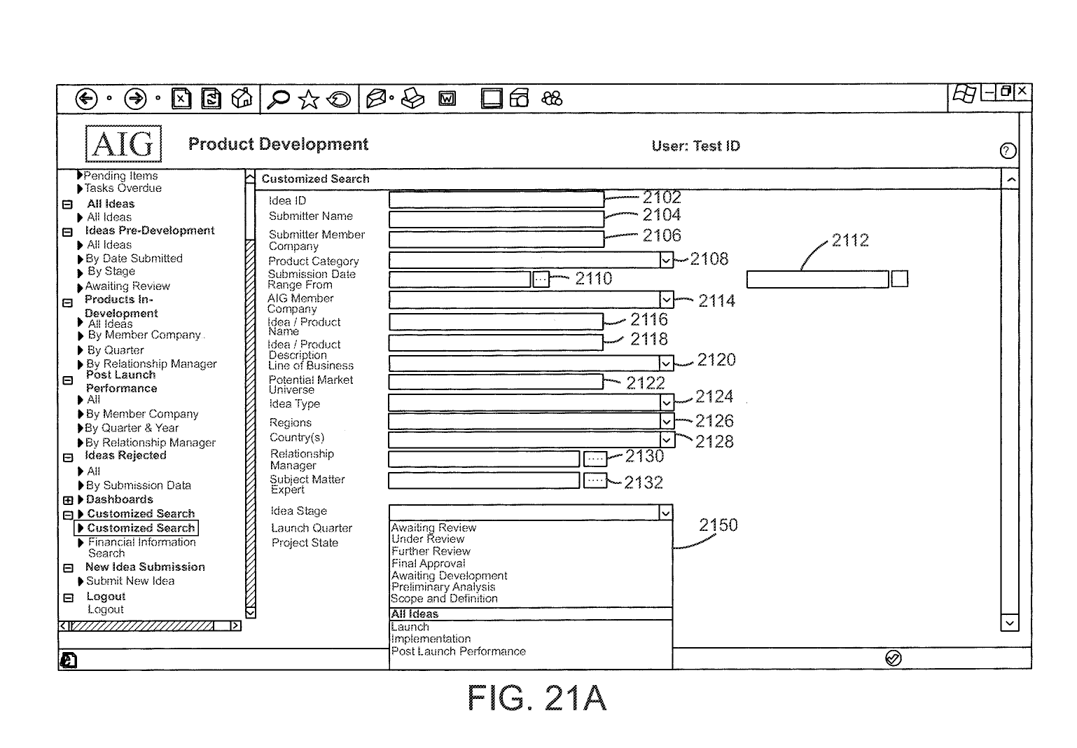

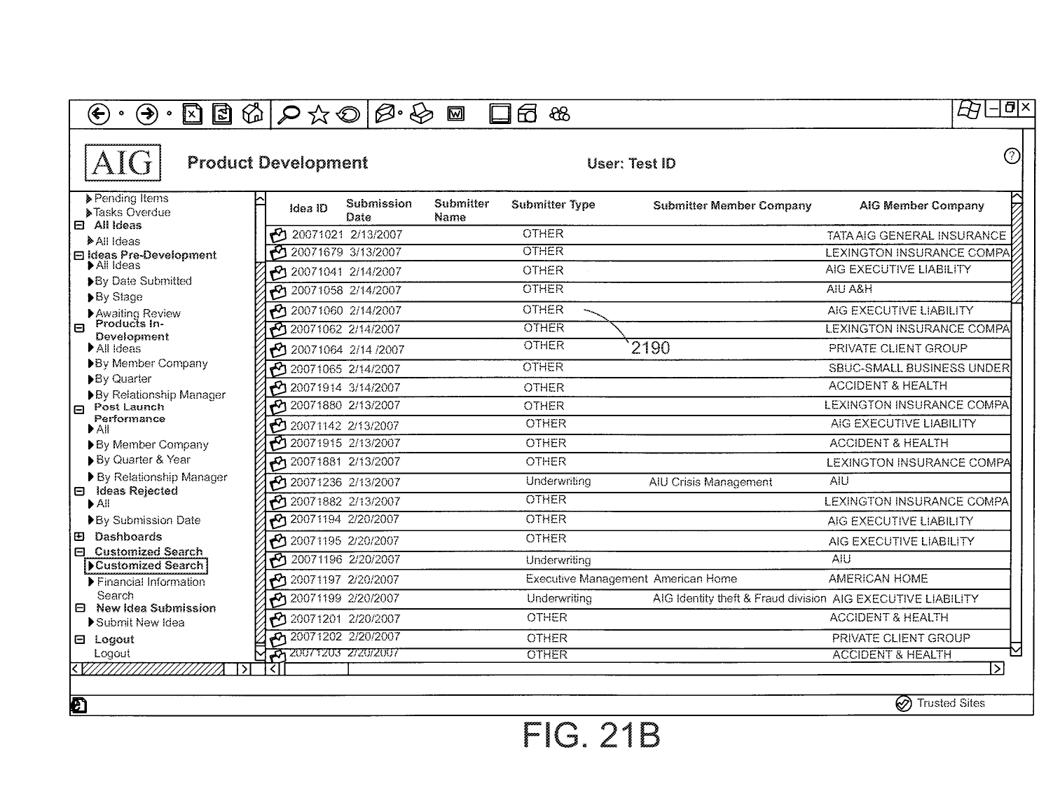

FIG. 21A is an exemplary user interface that allows a user to search the ITAM computer system for one or more product ideas based on search criteria entered by the user into data fields or selected from drop down menus. The search criteria may include an idea identification number 2102, submitter name 2104, submitter business unit 2106, product category 2108, submission date range (2110 and 2112), business unit 2114, idea/product name 2116, product description/keyword 2118, line of business 2120, Potential Market 2122, Idea Type 2124, Regions 2126, Countries 2128, RM 2130, subject matter expert 2132, idea stage 2150, and project state. FIG. 21B is a list of search results 2190 displayed on an exemplary user interface based on search criteria entered in a user interface shown in FIG. 21A.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for an insurance product development process in an insurance corporate environment, the method comprising:
receiving a new insurance product idea from one or more users submitted electronically using an idea submission software application running on at least one computer server;
storing the insurance product idea in an electronic repository using the idea submission software application;
producing work product for a stage in the insurance product development process;
organizing and storing work product for the insurance product development process in the electronic repository, according to each stage in the insurance product development process, using a process management software application running on the at least one computer server;
presenting tasks according to each stage in the insurance product development process on at least one graphical user interface, to the one or more users, using a task management software application running on the at least one computer server; and
presenting access to work product according to each stage in the insurance product development process on at least one graphical user interface, to the one or more users, using a document management software application running on the at least one computer server.

2. The method according to claim 1, the method further comprising identifying a plurality of insurance product types, a plurality of insurance product classifications, and a plurality of market trends to generate a new insurance product idea.

3. The method according to claim 2, wherein the insurance product types are selected from the group consisting of new coverage, modified existing coverage, and new service;
wherein the insurance product classifications are selected from the group consisting of new distributional channel, new service, new geography, new combination, new individual segment, and new emerging risk; and
wherein the market trends are selected from the group consisting of legislative modifications, regulatory modifications, new case law, litigation trends, societal shifts, economic swings, demographic shifts, and political shifts.

4. The method according to claim 1, the method further comprising:
developing the new insurance product idea into a new insurance product;
assessing the demand of the new insurance product from one or more potential customers, the financial underwriting impact of the new insurance product, and the different distribution channels to deliver the new insurance product; and
conducting a market evaluation for the new insurance product.

5. The method according to claim 1, the method further comprising:
creating a product development team wherein each member of the product development team assists in developing the new insurance product;
developing a project plan that provides a deadline for work product produced during the insurance product development process for the new insurance product;
creating a policy term sheet for the new insurance product;
formulating an operations and systems plan for developing the new insurance product; and
conducting a regulatory assessment for the new insurance product.

6. The method according to claim 1, the method further comprising:
constructing a rater for the new insurance product using a rater software application running on the at least one computer server;
creating an insurance application for the new insurance product wherein the insurance application is integrated with the rate using the rater software application;
creating underwriting guidelines for the new insurance product;
creating an insurance policy form template for the new insurance product; and
creating quote and bind letters for the new insurance product.

7. The method according to claim 1, the method further comprising branding the new insurance product, protecting he intellectual property of the new insurance product, designing a marketing campaign for the new insurance product, and formulating a distribution plan for the new insurance product.

8. The method according to claim 1, the method further comprising conducting surveys, focus groups, and interviews with one or more insurance brokers and one or more customers to validate the new insurance product.

9. The method according to claim 1, the method further comprising:
providing training for underwriters, managers, and insurance brokers using a training software application running on the at least one computer server;
conducting seminars presenting the new insurance product to one or more risk managers; and
planning a launch event to provide publicity for the new insurance product.

10. The method according to claim 1, the method further comprising:
tracking a plurality of premiums and revenue generated by the new insurance product;
monitoring the operations for delivering the new insurance product; and
reviewing the financial performance of the new insurance product.

11. The method according to claim 1, the method further comprising searching the electronic repository for the new insurance product idea based on different search criterion using a searching software application running on the at least one computer server.

12. The method according to claim 11, wherein the search criterion is selected from the group consisting of an idea identification number, submitter name, submitter business unit, product category, submission data range, business unit, product name, product description, line of business, potential market, type, regions, countries, relationship manager, subject matter expert, stage, and project state.

13. A computer system for an insurance product development process in an insurance corporate environment, the computer system comprising:
at least one computer server;
at least one idea submission software application running on the at least one computer server that receives an insurance product idea from one or more users;
a communication network connected to the at least one computer server;
at least one electronic database connected to the at least one computer server across the communication network that stores the insurance product idea; and
at least in graphical user interface presented to one or more users by the at least one computer server across the communication network.

14. The computer system according to claim 13, the system further comprising at least one process management software application, running on the at least one computer server, that organizes and stores work product in the at least one electronic database for a product development process according to a stage of the product development process.

15. The computer system according to claim 14, wherein the at least one process management software application presents the work product to one or more users in a list according to each stage of the product development process.

16. The computer system according to claim 13, the system further comprising at least one software dashboard application, running on the at least one computer server, that presents the number of insurance product launches and the development status of a plurality of insurance products on the at least one graphical user interface.

17. The computer system according to claim 14, the system further comprising at least one task management software application, running on the at least one computer server, presents a list of tasks for the insurance product development process on the at least on graphical user interface wherein the at least one task management software application presents the status, assignee, and deadline of each task wherein each task is organized by insurance product development process stage.

18. The computer system according to claim 14, the system further comprising at least one document management software application, running on the at least one computer server, presents a list of work product for the insurance product development process on the at least on graphical user interface wherein the at least one document management software application presents the status, assignee, and deadline of each work product wherein each work product is organized by product development process stage.

19. The computer system according to claim 18, wherein work product is selected from the group consisting of documents, spreadsheets, image files, video files, and audio files.
